(19) United States
(12) Patent Application Publication
(10) Pub. No.: US 2026/0352822 A1
(43) Pub. Date: Nov. 5, 2026

(54) METHODS AND DEVICES ON GEOMETRIC PARTITIONING MODE

(71) Applicant: BEIJING DAJIA INTERNET INFORMATION TECHNOLOGY CO., LTD., Beijing (CN)

(72) Inventors: Changyue MA, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN); Qi HUANG, Beijing (CN)

(73) Assignee: BEIJING DAJIA INTERNET INFORMATION TECHNOLOGY CO., LTD., Beijing (CN)

(21) Appl. No.: 19/721,691

(22) Filed: Jun. 26, 2026

Related U.S. Application Data
(63) Continuation of application No. PCT/CN2024/143206, filed on Dec. 27, 2024.

(30) Foreign Application Priority Data
Dec. 27, 2023 (WO) PCT/CN2023/142544

(51) Int. Cl. H04N 19/119; H04N 19/107; H04N 19/46; H04N 19/70

(52) U.S. Cl. CPC H04N 19/119; H04N 19/107; H04N 19/46; H04N 19/70

(57) ABSTRACT

Methods and apparatus are provided for decoding video data. The method generally includes determining a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry being associated with inter-prediction; obtaining template matching costs for different entries of the plurality of entries having different partition split modes and different prediction modes; obtaining a reordered candidate list based on the template matching costs; and determining one entry of the reordered candidate list indicated by an index in a bitstream.

### CROSS-REFERENCE TO RELATED APPLICATION

This application is based upon and claims priority to Application No. PCT/CN2023/142544 filed on Dec. 27, 2023. The entire content thereof is incorporated herein by reference in its entirety.

### TECHNICAL FIELD

This application is related to video coding and compression. More specifically, this application relates to methods and apparatus on improving the coding efficiency of geometric partitioning mode (GPM).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide to jointly reorder the split modes and the two prediction modes of GPM with template matching methods, where one prediction mode is inter mode, and the other prediction mode can be inter mode, intra mode, IBC mode, or Intra TMP mode.

Certain aspects of the present disclosure provide a method for decoding video data. The method generally includes determining a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry being associated with inter-prediction; obtaining template matching costs for different entries of the plurality of entries having different partition split modes and different prediction modes; obtaining a reordered candidate list based on the template matching costs; and determining one entry of the reordered candidate list indicated by an index in a bitstream.

Certain aspects of the present disclosure provide a method for encoding video data. The method generally includes determining a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry being associated with inter-prediction; obtaining template matching costs for different entries of the plurality of entries having different partition split modes and different prediction modes; obtaining a reordered candidate list based on the template matching costs; and transmitting an index indicating one entry of the reordered candidate list in a bitstream.

Certain aspects of the present disclosure provide an apparatus comprising one or more processors and one or more storage devices. The one or more storage devices store computer-executable instructions that, when being executed, cause the one or more processors to perform the operations of the method of any claimed methods in certain aspects fo the present disclosure.

Certain aspects of the present disclosure provide a computer program product storing computer-executable instructions that, when being executed, cause one or more processors to perform the operations of the method of any claimed methods in certain aspects of the present disclosure.

Certain aspects of the present disclosure provide a computer readable storage medium storing instructions which when executed by a computing device having one or more processors, cause the one or more processors to perform the decoding method according to certain aspects of the present disclosure and storing a bitstream to be decoded by the decoding method according to the certain aspects of the present disclosure.

Certain aspects of the present disclosure provide a computer readable storage medium storing instructions which when executed by a computing device having one or more processors, cause the one or more processors to perform the encoding method according to certain aspects of the present disclosure and storing a bitstream generated by the encoding method according to the certain aspects of the present disclosure.

Certain aspects of the present disclosure provide a computer readable medium storing a bitstream, wherein the bitstream is to be decoded by performing operations of a decoding method according to certain aspects of the present disclosure.

Certain aspects of the present disclosure provide a computer readable medium storing a bitstream, wherein the bitstream is obtained by performing operations of an encoding method according to certain aspects of the present disclosure.

Certain aspects of the present disclosure provide a method for receiving a bitstream to be decoded by a decoding method according to certain aspects of the present disclosure.

Certain aspects of the present disclosure provide a method for transmitting a bitstream generated by an encoding method according to certain aspects of the present disclosure.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5 illustrates a diagram of positions of spatial candidates;

FIG. 6 illustrates a diagram of candidate pairs considered for redundancy check of spatial candidates;

FIG. 7 illustrates a diagram of scaling of a motion vector for a temporal candidate;

FIG. 8 illustrates a diagram of candidate positions for a temporal candidate;

FIG. 9 illustrates a diagram of Merge mode with Motion Vector Difference (MMVD) search points;

FIGS. 10A and 10B illustrate diagrams of a control point based 4-parameter affine motion model and a control point based 6-parameter affine motion model respectively;

FIG. 11 illustrates affine motion vector prediction per subblock;

FIG. 12 illustrates control point motion vector inheritance;

FIG. 13 illustrates positions of candidates for constructed affine merge mode;

FIG. 14 illustrates spatial neighboring blocks used for Subblock-based Temporal Motion Vector Prediction (SbTMVP);

FIG. 15 illustrates derivation of motion fields of sub-CUs;

FIG. 16 illustrates an extended CU region used in Bi-Directional Optical Flow (BDOF);

FIG. 17 illustrates MV difference calculation in Prediction Refinement with Optical Flow (PROF);

FIG. 18 illustrates Sum of Absolute Difference (SAD) calculation in Decoder side Motion Vector Refinement (DMVR);

FIG. 19 illustrates uni-prediction motion vector selection for Geometric Partitioning Mode (GPM);

FIG. 20 illustrates top and left neighboring blocks used in CIIP weight derivation.

FIG. 21 illustrates the division method for angular modes.

FIG. 22 illustrates GPM with inter and intra prediction. Available IPM candidates (a)~(c). (d) Example of GPM with intra and intra prediction.

FIG. 23 illustrates the edge on templates.

FIG. 24 illustrates the ramp function for the weights for GPM blending based on the displacement (d) from a predicted sample position to the GPM partitioning boundary and the blending area size (t).

FIG. 25 illustrates spatial GPM candidates.

FIG. 26 illustrates GPM template.

FIG. 27 illustrates GPM blending.

FIG. 28 illustrates additional directions along kxx/8 diagonal angles (red positions are used in the anchor).

FIG. 29 illustrates a workflow of a method for decoding video data according to one or more aspects of the present disclosure.

FIG. 30 illustrates a workflow of a method for encoding video data according to one or more aspects of the present disclosure.

FIG. 31 is a diagram illustrating a computing environment coupled with a user interface, according to some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

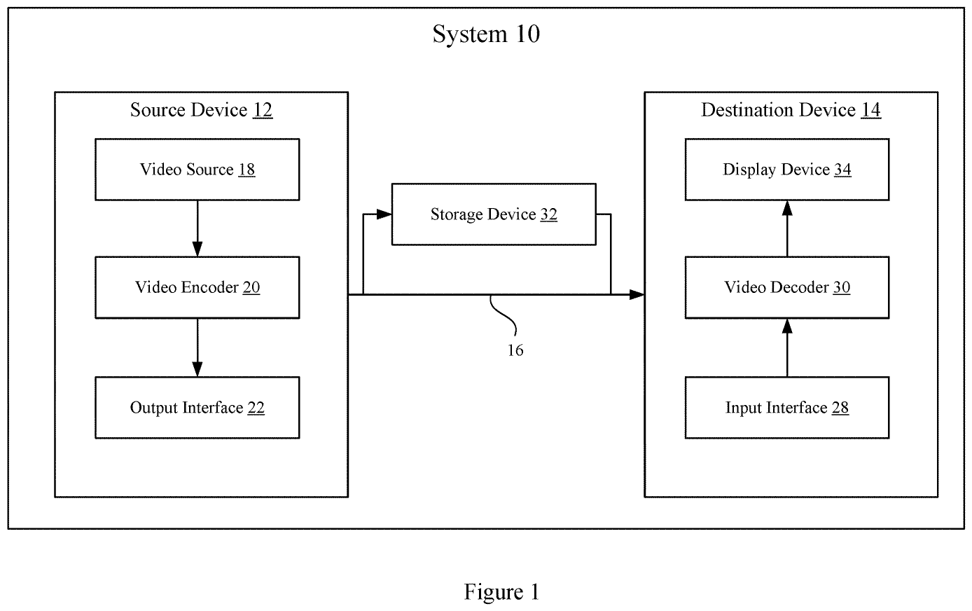

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

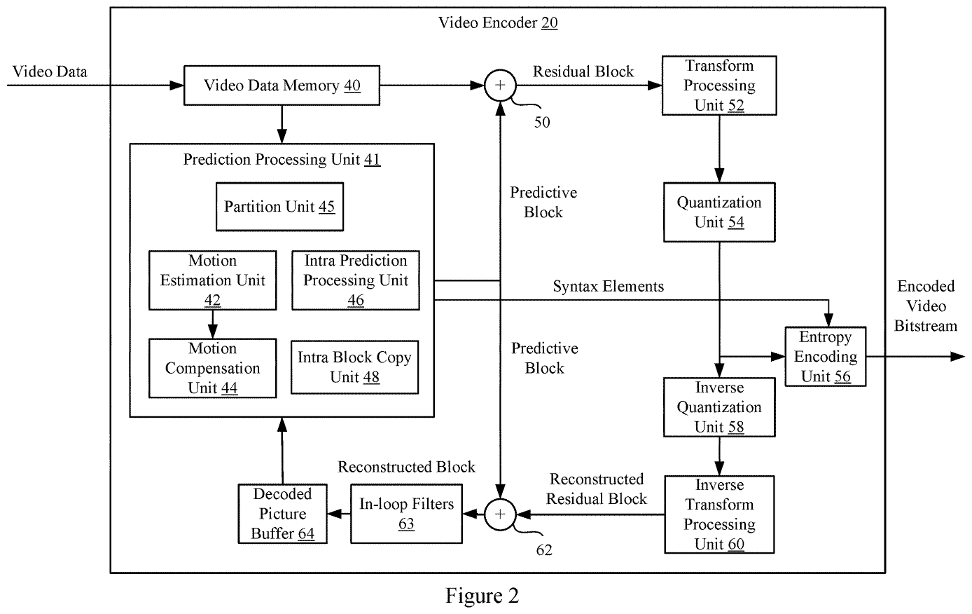

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

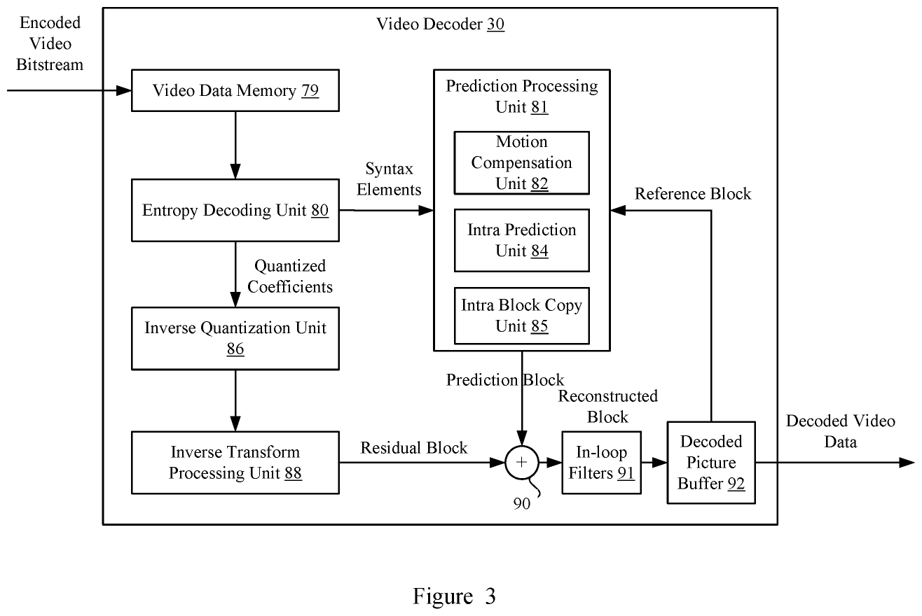

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

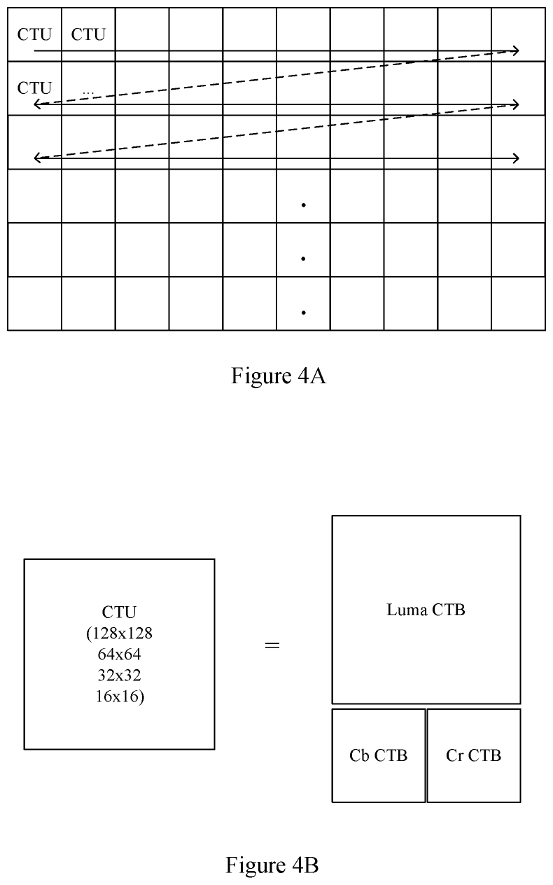

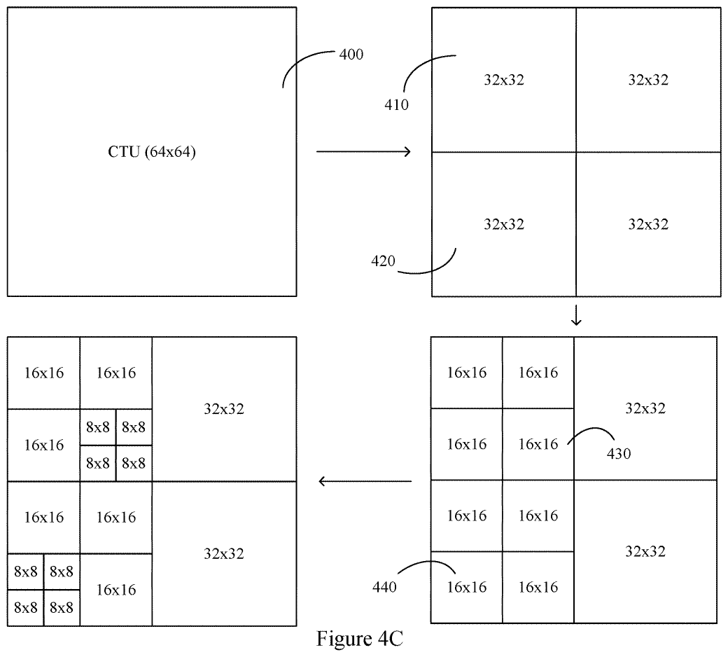

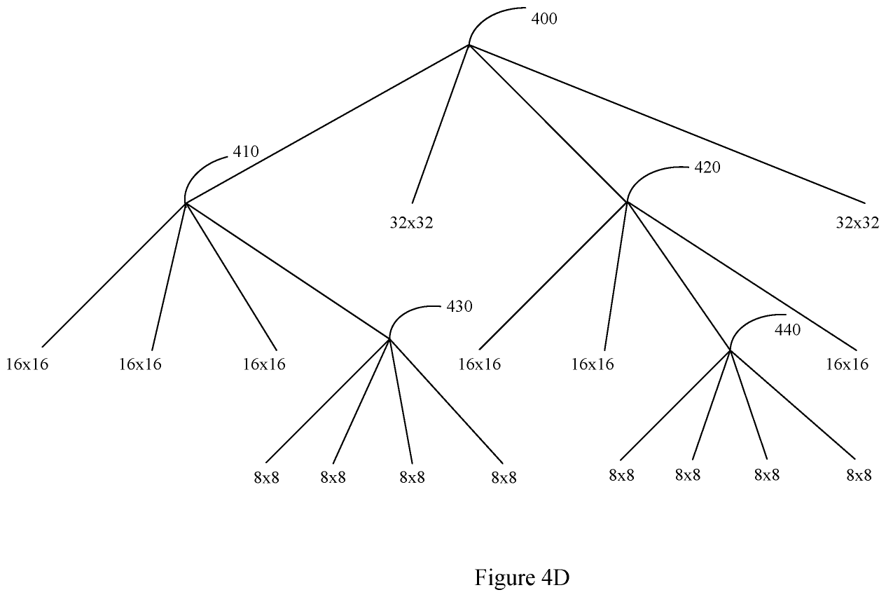

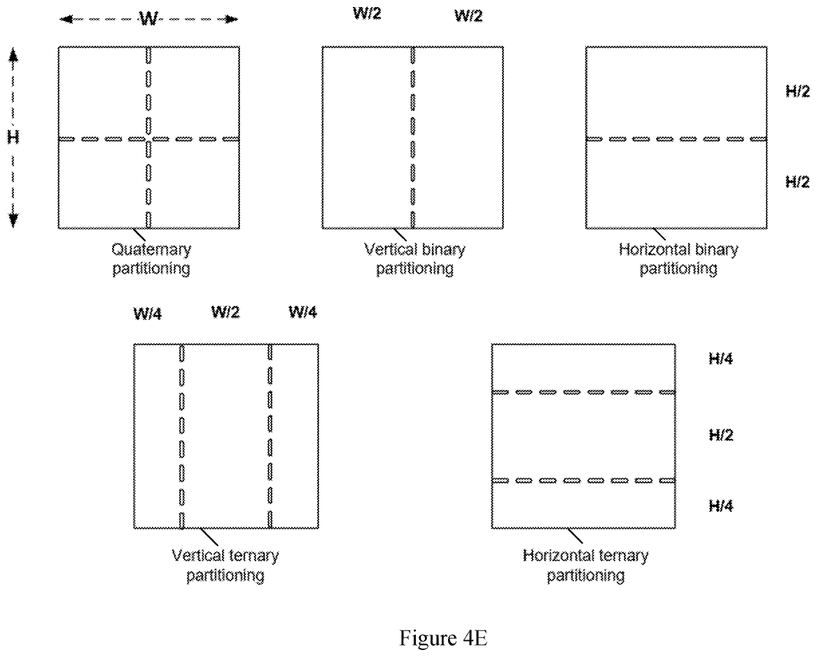

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more MxN PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

In general, the basic inter prediction scheme applied in VVC is almost kept the same as that of HEVC, except that several prediction tools are further extended, added and/or improved, e.g., extended merge prediction, MMVD, symmetric Motion Vector Difference (MVD) coding, affine motion compensation prediction, SbTMVP, Adaptive Motion Vector Resolution (AMVR), Bi-prediction with CU-level Weight (BCW), BDOF, PROF, DMVR, GPM, and Combined Inter and Intra Prediction (CIIP).

### Extended Merge Prediction

With the ever improving video data capturing technology and more refined video block size for preserving details in the video data, an amount of data required for representing motion vectors for a current picture also increases substantially. One way of overcoming this challenge is to use motion information (e.g., a motion vector) of a spatially neighboring CU, a temporally collocated CU etc. of a current CU as an approximation (e.g., prediction) of motion information of the current CU, which is also referred to as “Motion Vector Predictor (MVP)” of the current CU.

Like a process of choosing a predictive block in a reference picture during inter-prediction of a coding block, a set of rules need to be adopted by both the video encoder 20 and the video decoder 30 for constructing an MVP candidate list for a current CU and then selecting one MVP candidate from the MVP candidate list as an MVP for the current CU. By doing so, there is no need to transmit the MVP candidate list itself between the video encoder 20 and the video decoder 30, and an index of the MVP candidate selected from the MVP candidate list is sufficient for the video encoder 20 and the video decoder 30 to use the same MVP candidate selected from the MVP candidate list for encoding and decoding the current CU.

In VVC, the MVP candidate list is constructed by including the following five types of MVPs in order:
Spatial MVP from spatially neighboring CUs (i.e., spatial candidates);
Temporal MVP from temporally collocated CUs (i.e., temporal candidates);
History-based MVP (HMVP) from a First-In-First-Out (FIFO) table;
Pairwise average MVP; and
Zero MVPs.

A size of the MVP candidate list is signalled in a sequence parameter set header and a maximum allowed size of the MVP candidate list is 6. For each CU coded in merge mode, an index of the best MVP candidate is encoded using truncated unary binarization. A first bin of the index is coded with contexts and bypass coding is used for other bins of the index.

A derivation process of each type of MVPs is provided as follows. As in HEVC, VVC also supports parallel derivation of MVP candidate lists for all CUs within a certain size of area.

Derivation of MVPs from Spatial Candidates

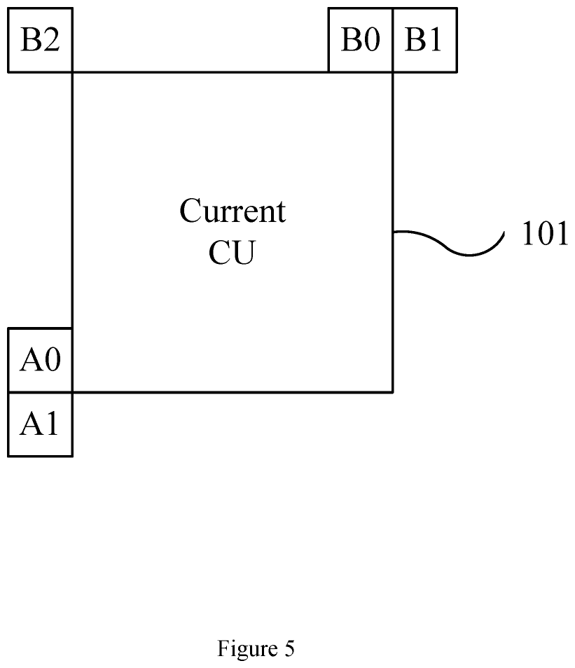

The derivation of MVPs from spatial candidates (for example, CUs neighboring a current CU 101 in FIG. 5) in VVC is the same as that in HEVC except that positions of first two spatial candidates are swapped. A maximum of four spatial candidates are selected from spatial candidates located at positions depicted in FIG. 5, that is, a top position B0, a left position A0, a top-right position B1, a bottom-left position A1 and a top-left position B2. The derivation is performed in an order of CUs at the positions B0, A0, B1, A1 and B2. A CU at the position B2 is considered only when one or more CUs at the positions B0, A0, B1 and A1 are not available (for example, because said one or more CUs belong to other slices or tiles) or is intra coded.

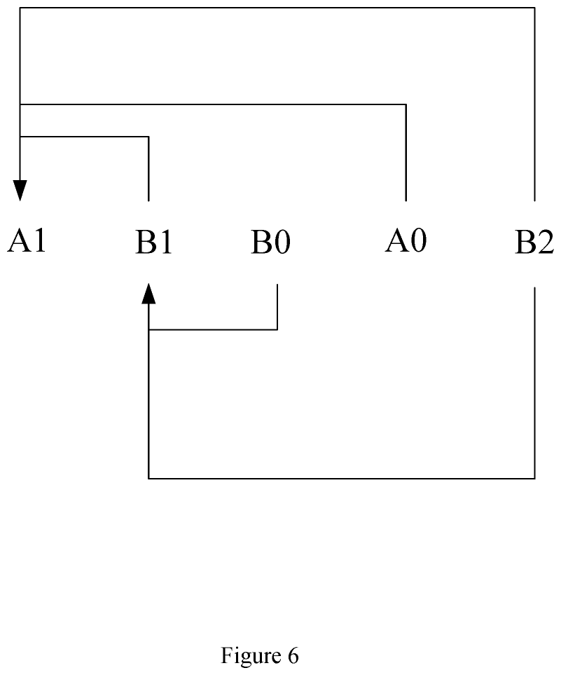

After a CU at the position B0 is added as a candidate to a merge candidate list, the addition of the remaining candidates to the merge candidate list is subject to redundancy check, which ensures that candidates with the same motion information are excluded from the merge candidate list, so that coding efficiency is improved. To reduce computational complexity, not all possible candidate pairs are considered in the redundancy check. Instead, only pairs linked using a line with an arrow in FIG. 6 are considered and a candidate is added to the merge candidate list only if a candidate in a corresponding pair used for the redundancy check has not the same motion information as that of the candidate to be added. Spatial MVPs derived from the candidates in the merge candidate list are added to the MVP candidate list.

Derivation of MVPs from Temporal Candidates

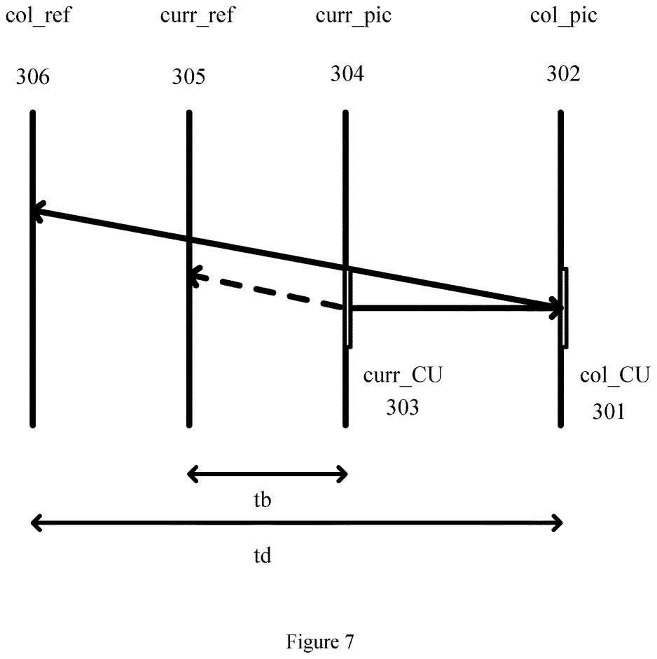

During the derivation of MVPs from temporal candidates, only one temporal candidate is added to the merge candidate list. Particularly, in the derivation of an MVP from this temporal candidate, a scaled motion vector is derived based on a collocated CU (for example, col_CU 301 in FIG. 7) as the temporal candidate belonging to a collocated picture (for example, col_pic 302 in FIG. 7) for a current CU (for example, curr_CU 303 in FIG. 7), and is added as a temporal MVP candidate to the MVP candidate list. A reference picture list and a reference picture index to be used for derivation of the collocated CU are explicitly signalled in a slice header. The scaled motion vector is obtained (i.e., scaled) from a motion vector of the collocated CU using Picture Order Count (POC) distances, i.e., tb and td, as illustrated in FIG. 7, where tb is defined to be a POC difference between a reference picture (for example, curr_ref 305 in FIG. 7) of the current picture (for example, curr_pic 304 in FIG. 7) and the current picture and td is defined to be a POC difference between a reference picture (for example, col_ref 306 in FIG. 7) of the collocated picture and the collocated picture. A reference picture index of the temporal candidate is set equal to zero.

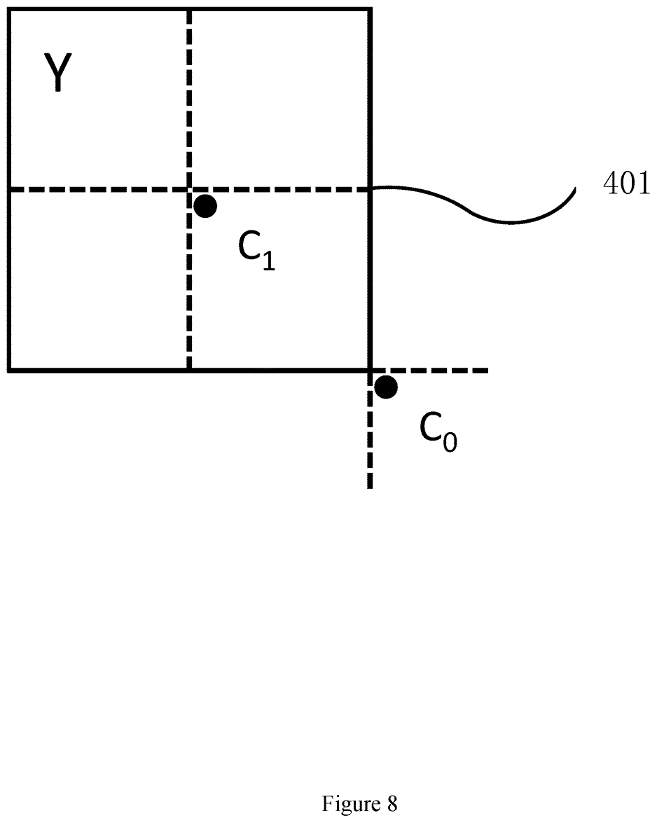

A position for the temporal candidate (i.e., the collocated CU) in the current CU 401 is selected between positions C₀ and C₁, as depicted in FIG. 8. If a CU at position C₀ in the collocated picture is not available, is intra coded, or is outside of a current row of CTUs, a CU at position C₁ is used as the collocated CU for the derivation of the temporal MVP candidate. Otherwise, a CU at position C₀ is used as the collocated CU for the derivation of the temporal MVP candidate.

### Derivation of HMVP Candidates

HMVP candidates are added to the MVP candidate list after the spatial MVPs and the temporal MVP. Motion information of a previously coded block is stored in an HMVP table and used as an MVP for the current CU. The table with multiple HMVP candidates is maintained during the encoding/decoding process. The table is reset (emptied) when a new row of CTUs is encountered. Whenever there is a non-subblock inter-coded CU, associated motion information is added to a last entry of the HMVP table as a new HMVP candidate.

A size of the HMVP table is set to 6. When a new HMVP candidate is inserted into the HMVP table, a constrained FIFO rule is utilized, wherein redundancy check is firstly applied to find whether there is an identical HMVP in the HMVP table. If found, the identical HMVP is removed from the HMVP table and all the HMVP candidates afterwards are moved forward, and the identical HMVP is added to the last entry of the HMVP table.

HMVP candidates may be used in the MVP candidate list construction process. The latest several HMVP candidates in the HMVP table are checked in order and inserted into the MVP candidate list after the temporal MVP candidate. Redundancy check is applied on the HMVP candidates relative to the spatial candidates and/or temporal MVP candidate.

To reduce a number of redundancy check operations, the following simplifications are introduced:
Last two entries in the HMVP table are redundancy checked relative to spatial MVP candidates derived from the spatial candidates at the positions A1 and B1, respectively; and
Once a total number of available MVP candidates reaches the maximum allowed size of the MVP candidate list minus 1, the MVP candidate list construction process from HMVP candidates is terminated.

### Derivation of Pairwise Average MVP Candidates

Pairwise average MVP candidates are generated by averaging MVPs derived using a predefined pair of first two merge candidates in the existing merge candidate list. A first merge candidate in the predefined pair may be defined as p0Cand and a second merge candidate in the predefined pair may be defined as p1Cand. Averaged motion vectors are calculated according to availability of motion vectors of p0Cand and p1Cand separately for each reference picture list. If both motion vectors are available for one reference picture list, these two motion vectors are averaged even when they point to different reference pictures, and a reference picture of the averaged motion vector is set to a reference picture of p0Cand; if only one motion vector is available for one reference picture list, the motion vector is used directly; if no motion vector is available for one reference picture list, the motion vector and the reference picture index for this reference picture list are kept invalid.

### Zero MVPs

When the MVP candidate list is not full after the pairwise average MVP candidates are added, zero MVPs are inserted at the end of the MVP candidate list until the maximum allowed size of the MVP candidate list is reached.

### MMVD

As described above, in the merge mode, motion information (i.e., an MVP candidate) is implicitly derived from an MVP candidate list constructed for a current CU and is directly used as an MV of the current CU for generation of prediction samples of the current CU, which may result in a certain error between an actual MV of the current CU and the implicitly derived MVP. In order to increase the accuracy of an MV of the current CU, MMVD is introduced in VVC where a Motion Vector Difference (MVD) of the current CU is added to the implicitly derived MVP to obtain the MV of the current CU. An MMVD flag is signalled after a regular merge flag is transmitted to specify whether an MMVD mode is used for the current CU.

In the MMVD mode, after an MVP candidate is selected from first two MVP candidates in the MVP candidate list, MMVD information is signalled, wherein the MMVD information includes an MMVD candidate flag which is used to specify which one of the first two MVP candidates is selected to be used as an MV basis, a distance index for indication of motion magnitude information of the MVD, and a direction index for indication of motion direction information of the MVD.

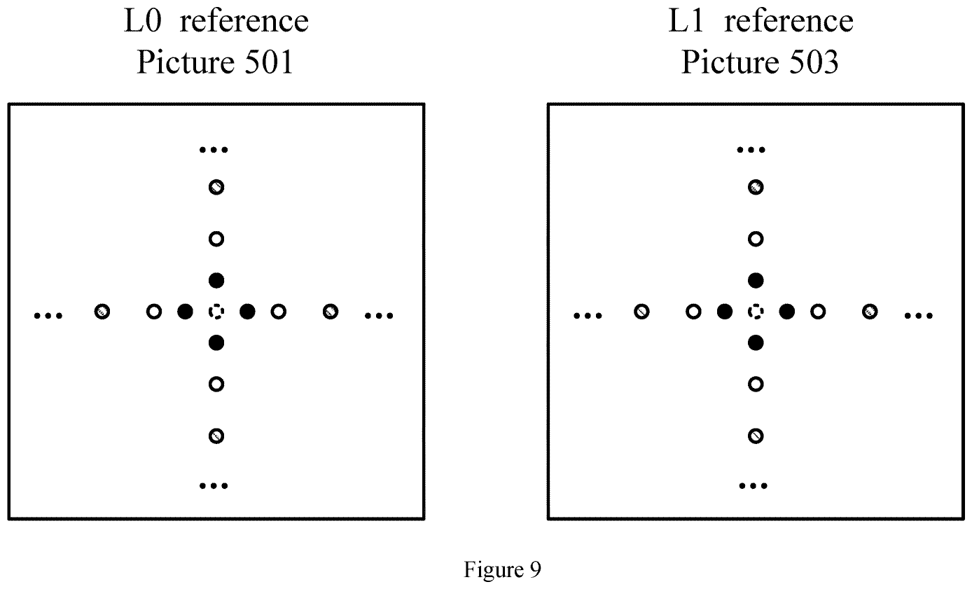

The distance index, which specifies the motion magnitude information of the MVD, indicates a pre-defined offset from a starting point (represented by, for example, a dotted circle in FIG. 9) in a reference picture (for example, L0 reference picture 501 or L1 reference picture 503 in FIG. 9) of the current CU to which the selected MVP candidate points, and the MVD may be derived from the offset and may be added to the selected MVP candidate. A relation between distance indexes and pre-defined offsets is specified in Table 1 below.

TABLE 1

| Distance index | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma samples) | | | | | | | | |

The direction index specifies a sign of the MVD, which represents a direction of the MVD relative to the starting point. Table 2 specifies a relation between direction indexes and pre-defined signs. It should be illustrated that the meaning of a sign of the MVD may be variant according to information of the selected MVP candidate. When the selected MVP candidate is an un-prediction MV or bi-prediction MVs with both MVs pointing to the same side of the current picture (i.e., POCs of two reference pictures (for example, reference pictures of list 0 and list 1, which are also referred to as L0 reference picture and L1 reference picture respectively) of the current picture are both greater than a POC of the current picture, or are both less than the POC of the current picture), the sign in Table 2 specifies the sign of the MVD added to the selected MVP candidate. When the selected MVP candidate is bi-prediction MVs with both MVs pointing to different sides of the current picture (i.e. a POC of one reference picture of the current picture is greater than the POC of the current picture, and a POC of the other reference picture of the current picture is less than the POC of the current picture), if a POC distance for L0 reference picture (i.e., a POC distance between the L0 reference picture and the current picture) is greater than a POC distance for L1 reference picture (i.e., a POC distance between the L1 reference picture and the current picture), the sign in Table 2 specifies a sign of an MVD for list 0 MVD0 added to an MVP for list 0 MVP0 of the selected MVP candidate and a sign of an MVD for list 1 MVD1 added to an MVP for list 1 MVP1 of the selected MVP candidate is opposite to the sign in Table 2; otherwise, if the POC distance for L1 reference picture is greater than the POC distance for L0 reference picture, the sign in Table 2 specifies the sign of MVD1 added to MVP1 and the sign of MVD0 added to MVP0 is opposite to the sign in Table 2.

TABLE 2

| Direction indexes | 00 | 01 | 10 | 11 |
|---|---|---|---|---|
| x-axis | + | − | N/A | N/A |
| y-axis | N/A | N/A | + | − |

The MVD is scaled according to the POC distances. If the POC distances for both L0 reference picture and L1 reference picture are the same, no scaling is needed for the MVD. Otherwise, if the POC distance for L0 reference picture is greater than the POC distance for L1 reference picture, MVD1 is scaled. If the POC distance for L1 reference picture is greater than the POC distance for L0 reference picture, MVD0 is scaled.

### Symmetric MVD Coding

In VVC, besides normal MVD signalling in a uni-directional prediction mode and a bi-directional prediction mode, a symmetric MVD mode for MVD signalling in a bi-directional prediction mode is applied. In the symmetric MVD mode, motion information including indexes of reference pictures in both list 0 and list 1 and an MVD associated with list 1 are not signalled from the encoder 20 but are derived at the decoder 30.

A decoding process of the symmetric MVD mode is as follows.

At a slice level, a variable BiDirPredFlag and reference picture indexes RefIdxSymL0 and RefIdxSymL1 for a current picture are derived as follows:
If a flag mvd_11_zero_flag is 1, the variable BiDirPredFlag is set equal to 0, wherein the flag mvd_11_zero_flag indicates whether MVDs of various CUs associated with list 1 in a slice of the current picture are 0 or not;
Otherwise, if a reference picture in list 0 closest to the current picture and a reference picture in list 1 closest to the current picture form a forward and backward pair of reference pictures or a backward and forward pair of reference pictures, the variable BiDirPredFlag is set to 1; otherwise, BiDirPredFlag is set to 0.

At a CU level, if a current CU is bi-predictively coded and the variable BiDirPredFlag is equal to 1, a symmetrical MVD mode flag indicating whether a symmetrical MVD mode is used or not is explicitly signalled.

RefIdxSymL0 and RefIdxSymL1 are set to indexes of the reference pictures in list 0 and list 1 respectively.

When the symmetrical MVD mode flag is true, only an MVP index for list 0 mvp_10_flag, an MVP index for list 1 mvp_11_flag and an MVD for list 0 MVD0 (mvdx₀, mvdy₀) are explicitly signalled. An MVP for list 0 MVP0 (mvpx₀, mvpy₁) is derived based on the MVP index for list 0 mvp_10_flag and the MVP candidate list described above, and an MVP for list 1 MVP1 (mvpx₁, mvpy₁) is derived based on the MVP index for list 1 mvp_11_flag and the MVP candidate list described above. An MVD for list 1 MVD1 (mvdx₁, mvdy₁) is set equal to (−mvdx₀,−mudy₀). A final motion vector MV for list 0 MV0 (mvx₀, mvy₀) and a final motion vector MV for list 1 MV1 (mvx₁, mvy₁) are derived respectively using the following equation:

(mvx₀,mvy₁)=(mvpx₀+mvdx₀,mvpy₀+mvdy₁)

(mvx₁,mvy₁)=(mvpx₁−mvdx₀,mvpy₁−mvdy₁) (1)

### Affine Motion Compensation Prediction

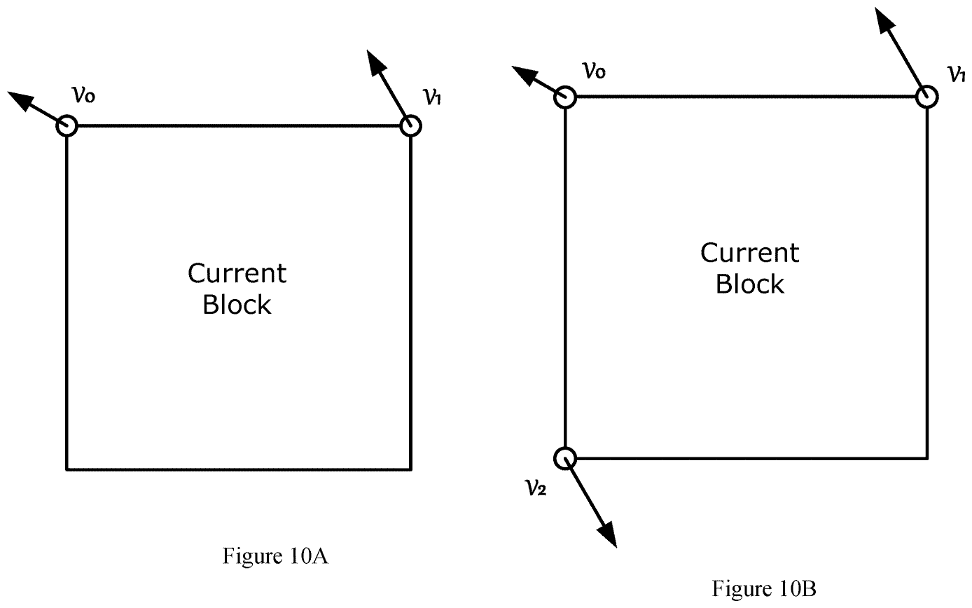

In HEVC, only a translational motion model is applied for motion compensation prediction. While in the real world, there are many kinds of motions, e.g., zoom in/out, rotation, perspective motions and the other irregular motions. In VVC, a block-based affine motion compensation prediction is applied. As shown in FIGS. 10A and 10B, an affine motion field of a block is described by two Control Point Motion Vectors (CPMVs) (for a 4-parameter affine motion model) or three CPMVs (for a 6-parameter affine motion model).

For the 4-parameter affine motion model, a motion vector (mvₓ, mv_{y}) at a sample position (x, y) in the current block is derived as:

$$\{ \begin{matrix}m {v}_{x} = \frac{m {v}_{1 x} - m {v}_{0 x}}{W} x - \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 X} - m {v}_{0 x}}{W} y + m {v}_{0 y}\end{matrix} \qquad ( 2 )$$

where (mv₀ₓ, mv_{0y}) is a motion vector v₀ of a top-left corner control point, (mv₁ₓ, mv_{1y}) is a motion vector v₁ of a top-right corner control point, W is a width of the block, and His a height of the block.

For the 6-parameter affine motion model, a motion vector (mvₓ, mv_{y}) at the sample position (x, y) in the current block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 3 )$$

where (mv₀ₓ, mv_{0y}) is a motion vector v₀ of a top-left corner control point, (mv₁ₓ, mv_{1y}) is a motion vector v₁ of a top-right corner control point, (mv₂ₓ, mv_{2y}) is a motion vector v₂ of a bottom-left corner control point, W is a width of the block, and His a height of the block.

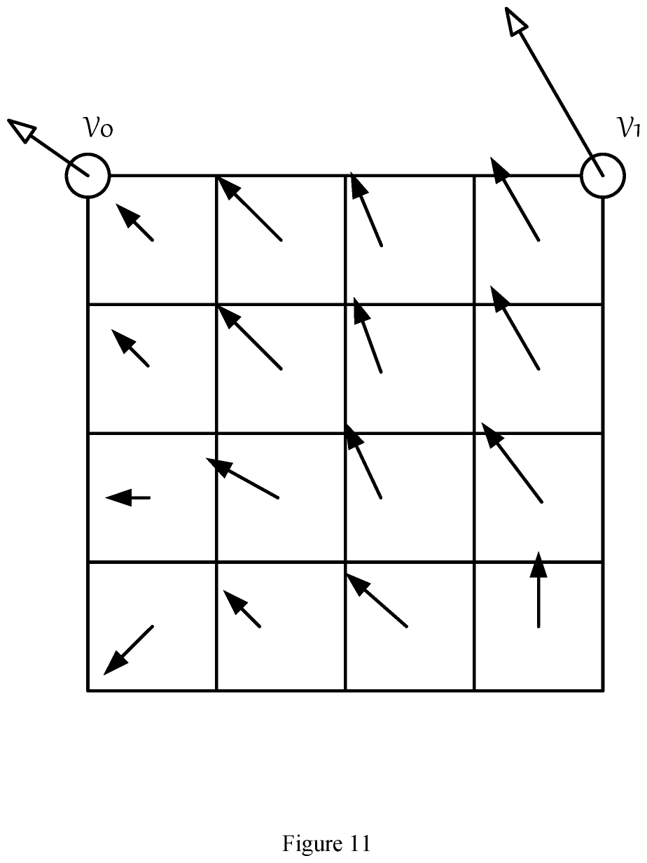

In order to simplify the motion compensation prediction, block-based affine motion compensation prediction is applied. To derive a motion vector of each 4×4 luma subblock, a motion vector of a central sample of each subblock, as shown in FIG. 11, is calculated according to the above equations, and is rounded to 1/16 fraction accuracy. Then motion compensation interpolation filters are applied to generate prediction of each subblock with the derived motion vector. A size of a chroma subblock is also set to be 4×4. An MV of a 4×4 chroma subblock is calculated as an average of MVs of top-left and bottom-right luma subblocks in a collocated 8×8 luma region.

As done for translational motion inter-prediction, there are also two affine motion inter-prediction modes: an affine merge mode and an affine Advanced Motion Vector Prediction (AMVP) mode.

### Affine Merge Prediction

An affine merge mode may be applied to CUs with both a width and a height thereof being greater than or equal to 8. In the affine merge mode, CPMVs of a current CU are generated based on motion information (for example, CPMV candidates) of spatially neighboring CUs of the current CU etc. There may be up to five CPMV candidates from which an affine merge candidate list is constructed, and an index is signalled to indicate a CPMV candidate to be used for decoding the current CU. The affine merge candidate list may be formed by the following three types of CPMV candidates:
inherited affine merge candidates that are extrapolated from CPMVs of neighboring CUs of the current CU;
constructed affine merge candidates that are derived using translational MVs of neighboring CUs of the current CU; and
zero MVs.

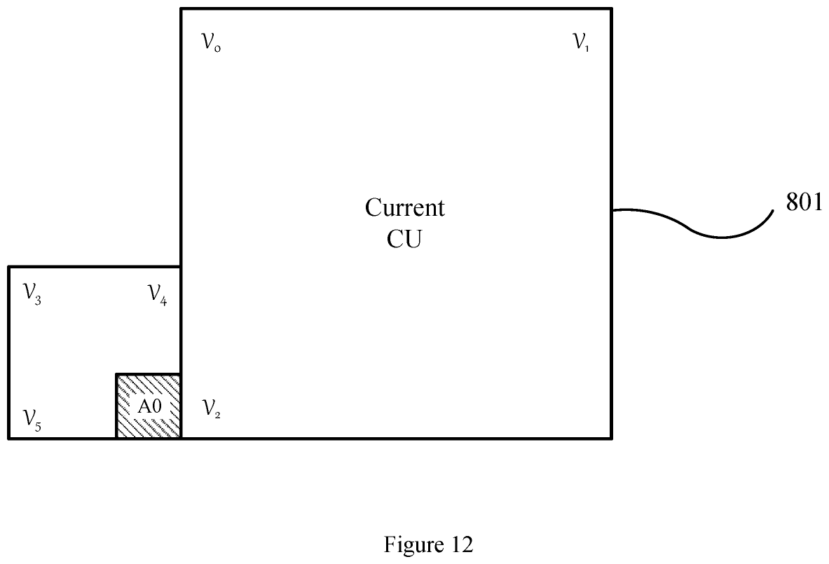

In VVC, there are a maximum of two inherited affine merge candidates, which are derived from affine motion models of neighboring CUs as shown in FIG. 5. One of the neighboring CUs is selected from neighboring CUs at A0 and A1 on one side left to the current CU in an order of A1 and A0 and the other of the neighboring CUs is selected from neighboring CUs at B0, B1 and B2 on one side above the current CU in an order of B1, B0 and B2. Only a first inherited affine merge candidate on each side is selected. No pruning check is performed between the two inherited affine merge candidates. When a neighboring CU is identified, its CPMVs are used to derive a CPMV candidate in the affine merge candidate list of the current CU. For example, as shown in FIG. 12, if a neighboring left-bottom CU at A0 is coded in the affine mode, motion vectors v₃, v₄ and v₅ at a top-left corner, an above-right corner and a left-bottom corner of the CU at A0 are attained. When the CU at A0 is coded in a 4-parameter affine model, two CPMVs v₀ and v₁ of the current CU 801 are obtained according to v₃ and v₄. When the CU at A0 is coded in a 6-parameter affine model, three CPMVs v₀, v₁ and v₂ of the current CU 801 are obtained according to v₃, v₄ and v₅.

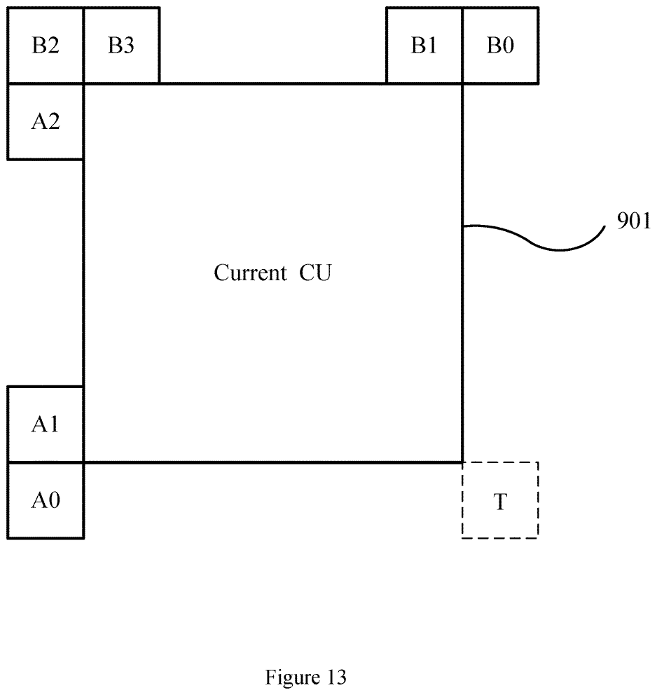

A constructed affine merge candidate of the current CU means a candidate which is constructed by combining neighboring translational motion information for control points of the current CU. The motion information for the control points is derived from predetermined spatially neighboring CUs and temporally neighboring CUs shown in FIG. 13. Assuming that CPMVₖ (k=1, 2, 3, 4) represents a CPMV of a kth control point, for CPMV₁, CUs at B2, B3 and A2 of the current CU are checked in an order of CUs at B2, B3 and A2 and an MV of a first available CU is used as CPMV₁; for CPMV₂, CUs at B1 and B0 of the current CU 901 are checked in an order of CUs at B1 and B0, and an MV of a first available CU is used as CPMV₂; for CPMV₃, CUs at A1 and A0 of the current CU 901 are checked in an order of CUs at A1 and A0, and an MV of a first available CU is used as CPMV₃; and for CPMV₄, a Temporal Motion Vector Predictor (TMVP) is used as CPMV₄ if the TMVP is available.

After the CPMVs of the four control points are obtained, 6-parameter affine merge candidates are constructed by combining some of the obtained CPMVs in an order as follows: {CPMV₁, CPMV₂, CPMV₃}, {CPMV₁, CPMV₂, CPMV₄}, {CPMV₁, CPMV₃, CPMV₄}, and {CPMV₂, CPMV₃, CPMV₄}, and 4-parameter affine merge candidates are constructed by combining some of the obtained CPMVs in an order as follows: {CPMV₁, CPMV₂}, and {CPMV₁, CPMV₃}.

To avoid a motion scaling process, if reference picture indexes for control points are different, the combination of associated CPMVs thereof is discarded.

After the inherited affine merge candidates and the constructed affine merge candidates are checked, if the affine merge candidate list is still not full, zero MVs may be inserted at the end of the affine merge candidate list.

### Affine AMVP Prediction

An affine AMVP mode may be applied to CUs with both a width and a height thereof being greater than or equal to 16. An affine flag at a CU level is signalled in a bitstream to indicate whether the affine AMVP mode is used and then another flag is signalled to indicate whether a 4-parameter affine mode or a 6-parameter affine mode is used. In the affine AMVP mode, differences between the best CPMVs of the current CU and CPMVs selected from an affine AMVP candidate list may be signalled in the bitstream, and may be added to CPMVs of the current CU derived at the video decoder 30 to obtain final CPMVs of the current CU. A maximum allowable size of the affine AMVP candidate list is 2 and the affine AMVP candidate list is generated by using the following four types of CPMV candidates in order:
inherited affine AMVP candidates that extrapolated from the CPMVs of neighboring CUs of the current CU;
constructed affine AMVP candidates that are derived using translational MVs of neighboring CUs of the current CU;
translational MVs from neighboring CUs of the current CU; and
zero MVs.

A checking order of inherited affine AMVP candidates is the same as that of the inherited affine merge candidates described above, except that for an affine AMVP candidate, only a neighboring CU that has the same reference picture as that of the current CU is considered. No pruning process is applied when an inherited affine AMVP candidate is inserted into the affine AMVP candidate list.

The constructed affine AMVP candidates are derived from the predetermined spatially neighboring CUs shown in FIG. 13. The same checking order is used as done in the construction of the affine merge candidates. In addition, reference picture indexes of the neighboring CUs are also checked. A first neighboring CU in the checking order that is inter-coded and has the same reference picture as that of the current CU is used. Only one constructed affine AMVP candidate is inserted into the affine AMVP candidate list.

If a size of the affine AMVP candidate list is still less than 2 after the inherited affine AMVP candidates and the constructed affine AMVP candidate are inserted, the translational MVs from the neighboring CUs are considered to predict CPMVs of the current CU, when the translational MVs are available. Finally, zero MVs are used to fill the affine AMVP candidate list if the affine AMVP candidate list is still not full.

### SbTMVP

Similarly to TMVP in HEVC, SbTMVP in VVC uses a motion field in a collocated picture of a current picture to improve motion vector prediction and a merge mode for CUs in the current picture. Derivation of the collocated picture for SbTMVP is the same as that for TMVP. SbTMVP differs from TMVP in the following two main aspects:
firstly, TMVP predicts motion information at a CU level but SbTMVP predicts motion information at a sub-CU level; and
secondly, TMVP obtains temporal motion information from a collocated CU in the collocated picture (the collocated CU is a bottom-right or central block relative to a current CU), while SbTMVP applies a motion shift before obtaining temporal motion information from the collocated picture, where the motion shift is obtained from a motion vector from one of spatial neighboring blocks of the current CU.

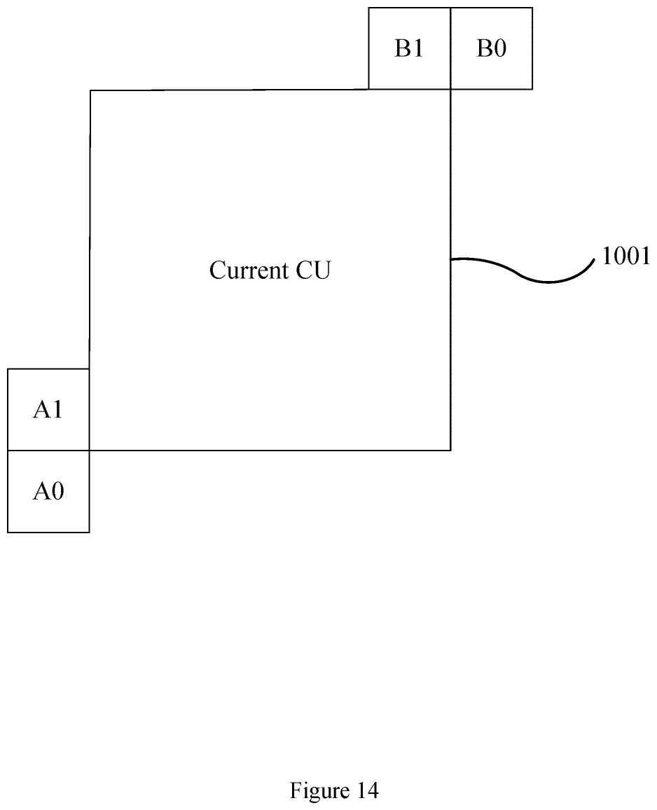

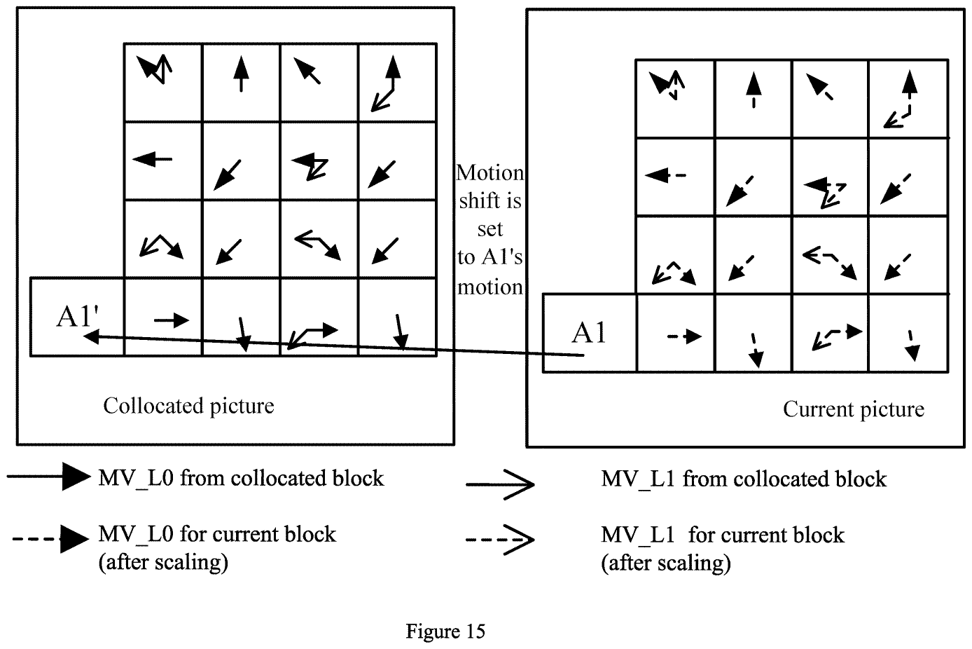

The SbTMVP process is illustrated in FIGS. 14 and 15. SbTMVP predicts motion vectors of sub-CUs within the current CU 1001 using two steps. In a first step, a spatially neighboring block at A1 in FIG. 14 is examined. If the spatially neighboring block at A1 has a motion vector that uses the collocated picture as its reference picture, this motion vector is selected to be the motion shift to be applied. If no such motion is identified, then the motion shift is set to (0, 0).

In a second step, the motion shift is applied (i.e., added) to coordinates of the current CU to obtain a collocated CU in the collocated picture, so as to obtain sub-CU-level motion information (motion vectors and reference indexes) from the collocated picture as shown in FIG. 15. The example in FIG. 15 assumes that the motion shift is set to the motion vector of the spatially neighboring block at A1. Then, for each sub-CU in the current picture, motion information of a collocated block in the collocated picture is used to derive the motion information of the sub-CU. After the motion information of the collocated block is identified, it is converted to the motion vectors and reference indexes of the current sub-CU using temporal motion scaling in a similar way to that in the TMVP process of HEVC.

In VVC, a combined subblock based merge list which contains both an SbTMVP candidate and affine merge candidates may be used for signalling of a subblock based merge mode. An SbTMVP mode is enabled/disabled by a Sequence Parameter Set (SPS) flag. If the SbTMVP mode is enabled, an SbTMVP predictor is added as a first entry into the combined subblock based merge list, followed by the affine merge candidates. A size of the combined subblock based merge list is signalled in an SPS and a maximum allowed size of the combined subblock based merge list is 5.

A size of a sub-CU used in SbTMVP is fixed to be 8×8, and as done for the affine merge mode, the SbTMVP mode is only applicable to a CU with both a width and a height thereof being greater than or equal to 8.

### AMVR

In HEVC, MVDs (between motion vectors and predicted motion vectors of CUs) are signalled in unit of quarter-luma-sample (e.g., ¼ pel) when a flag use_integer_mv_flag is equal to 0 in a slice header. In VVC, a CU-level AMVR scheme is introduced. AMVR allows an MVD of a CU to be coded in different precisions. Dependent on a mode (a normal AMVP mode or an affine AMVP mode) for the current CU, precisions of the MVD (also referred to as MVD precisions below) of the current CU may be adaptively selected as follows:
for the normal AMVP mode, quarter-luma-sample, half-luma-sample (e.g., ½ pel), integer-luma-sample (e.g., 1 pel) or four-luma-sample (e.g., 4 pel) is selected as the precision of the MVD; and
for the affine AMVP mode, quarter-luma-sample, integer-luma-sample or 1/16 luma-sample (e.g., 1/16 pel) is selected as the precision of the MVD.

The CU-level MVD precision indication is conditionally signalled if at least one MVD component of the current CU is non-zero. If all MVD components (that is, both horizontal and vertical MVDs for reference picture list L0 and reference picture list L1) are zero, quarter-luma-sample MVD precision (i.e., an MVD resolution of quarter-luma-sample) is inferred.

When at least one MVD component of a CU is non-zero, a first flag is signalled to indicate whether the quarter-luma-sample MVD precision is used for the CU. If the first flag is 0, no further signalling is needed and the quarter-luma-sample MVD precision is used for the current CU. Otherwise, in a case of a CU in the normal AMVP mode, a second flag is signalled to indicate whether half-luma-sample MVD precision (i.e., an MVD precision of half-luma-sample) or another MVD precision (integer-luma-sample MVD precision (i.e., an MVD precision of integer-luma-sample) or four-luma-sample MVD precision (i.e., an MVD precision of four-luma-sample) is used for the CU in the normal AMVP mode. In a case of the half-luma-sample MVD precision, a 6-tap interpolation filter instead of a default 8-tap interpolation filter is used for a half-luma sample position. Otherwise, a third flag is signalled to indicate whether the integer-luma-sample MVD precision or the four-luma-sample MVD precision is used for the CU in the normal AMVP mode. In a case of a CU in the affine AMVP mode, a second flag is signalled to indicate whether the integer-luma-sample MVD precision or 1/16 luma-sample MVD precision is used. In order to ensure that the reconstructed MV has the intended precision (quarter-luma-sample, half-luma-sample, integer-luma-sample, or four-luma-sample for the normal AMVP mode, and quarter-luma-sample, integer-luma-sample or 1/16 luma-sample for the affine AMVP mode), motion vector predictors of the CU will be rounded to the same precision as that of the MVD before being added to the MVD. The motion vector predictors are rounded toward zero (that is, a negative motion vector predictor is rounded toward positive infinity and a positive motion vector predictor is rounded toward negative infinity).

### BCW

In HEVC, in a bi-prediction mode, a bi-prediction signal is generated by averaging two prediction signals obtained from two different reference pictures and/or using two different motion vectors. In VVC, the bi-prediction mode is extended beyond simple averaging to allow weighted averaging of the two prediction signals (i.e., BCW) using the following equation to obtain a bi-predicted signal P_{bi-pred}:

P_{bi-pred}=((8−w)*P₀+w*P₁+4)>>3 (4)
where P₀ and P₁ are the two prediction signals, w is a weight for weighted averaging bi-prediction, w∈{−2, 3, 4, 5, 10}, that is, five weights are allowed in the weighted averaging bi-prediction, and >> represents a right shift operation. For example, when w is equal to 4, equal weights are selected for BCW, and when w is equal to −2, 3, 5 or 10, unequal weights are selected for BCW. For each bi-predicted CU, the weight w is determined in one of two ways: 1) for a non-merge CU, a weight index of the weight w is signalled after the motion vector difference for the CU; 2) for a merge CU, the weight index of the weight w is inferred from neighboring blocks based on a merge candidate index of the CU. BCW is only applied to a CU with 256 or more luma samples (i.e., the multiplication of the width and the height of the CU is greater than or equal to 256). For low-delay pictures, all of the five weights are used. For non-low-delay pictures, only three weights of the five weights are used, i.e., w∈{3, 4, 5}.

At the video encoder 20, fast search algorithms are applied to find the weight index without significantly increasing the encoder complexity. These algorithms are summarized as follows:
When combined with AMVR, unequal weights are only conditionally checked for 1-pel and 4-pel motion vector precisions if the current picture is a low-delay picture.
When combined with affine mode, affine Motion Estimation (ME) will be performed for unequal weights if and only if the affine mode is selected as the current best mode.
When two reference pictures in bi-prediction are the same, unequal weights are only conditionally checked.
Unequal weights are not searched when certain conditions are met, depending on a POC distance between a current picture and its reference pictures, a coding QP, and a temporal level.

The BCW weight index (i.e., the weight index for BCW) is coded using one context coded bin followed by bypass coded bins. The first context coded bin indicates whether equal weights are used; and if unequal weights are used, additional bins are signalled using bypass coding to indicate which unequal weights are used.

Weighted Prediction (WP) is a coding tool supported by the H.264/AVC and HEVC standards to efficiently code video content with fading. Support for WP is also added into the VVC standard. WP allows weighting parameters (a weight and an offset) to be signalled for each reference picture in each of reference picture lists L0 and L1. Then, during motion compensation, the weight(s) and offset(s) for the corresponding reference picture(s) are applied. WP and BCW are designed for different types of video content. If WP is applied for a CU, then the BCW weight index is not signalled, and w is inferred to be 4 (i.e., equal weights are applied). For a merge CU, the weight index is inferred from neighboring blocks based on the merge candidate index. This may be applied to both normal merge mode and inherited affine merge mode. For constructed affine merge mode, the affine motion information is constructed based on the motion information of up to three blocks. The BCW weight index for a CU using the constructed affine merge mode is simply set equal to a BCW weight index of a first control point MV.

In VVC, CIIP and BCW cannot be jointly applied for a CU. When a CU is coded with a CIIP mode, the BCW weight of the current CU is set to 4, i.e., using equal weights.

### BDOF

The BDOF tool is newly included in VVC. BDOF is used to refine a bi-prediction signal of a CU at a 4×4 subblock level. BDOF is applied to a CU if it satisfies all the following conditions:
The CU is coded using “true” bi-prediction mode, i.e., one of two reference pictures of a current picture is prior to the current picture in a display order and the other is after the current picture in the display order;
Distances (i.e. POC differences) from the two reference pictures to the current picture are same;
Both of the reference pictures are short-term reference pictures;
The CU is not coded using affine mode or SbTMVP merge mode;
The CU has more than 64 luma samples;
Both a height and a width of the CU are larger than or equal to 8 luma samples;
A BCW weight index indicates equal weights;
WP is not enabled for the current CU; and
CIIP mode is not used for the current CU.

BDOF is only applied to the luma component. The BDOF mode is based on the optical flow concept, which assumes that motion of an object is smooth. For each 4×4 subblock, a motion refinement (vₓ, v_{y}) is calculated by minimizing a difference between L0 and L1 prediction samples. The motion refinement is then used to adjust bi-predicted sample values in the 4×4 subblock. The following steps are applied in the BDOF process.

Firstly, for k=0 and 1, horizontal and vertical gradients, ∂I^{(k)}/∂x(i,j) and ∂I^{(k)}/∂y(i,j) of a prediction signal for list k from the two prediction signals are computed by directly calculating a difference between two neighboring samples of a sample at a coordinate (i,j) of the corresponding prediction signal in respective horizontal and vertical directions, i.e.,

$$\frac{\partial {I}^{( k )}}{\partial x} ( i , j ) = ( ( {I}^{( k )} ( i + 1 , j ) >> 6 ) - ( {I}^{( k )} ( i - 1 , j ) >> 6 ) ) \qquad ( 5 )$$

$$\frac{\partial {I}^{( k )}}{\partial y} ( i , j ) = ( ( {I}^{( k )} ( i , j + 1 ) >> 6 ) - ( {I}^{( k )} ( i , j - 1 ) >> 6 ) )$$

where I^{(k)}(i+1,j) and I^{(k)}(i−1,j) are the two neighboring samples of the sample I^{(k)}(i,j) at the coordinate (i,j) of the prediction signal for list k in the horizontal direction, I^{(k)}(i,j+1) and I^{(k)}(i, j−1) are the two neighboring samples of the sample I^{(k)}(i,j) at the coordinate (i,j) of the prediction signal for list k in the vertical direction, and >> represents a right shift operation.

Then, auto-correlation and cross-correlation S₁, S₂, S₃, S₄ and S₅ of the gradients are calculated as:

$${S}_{1} = {\sum }_{( i , j ) ∈ Ω} Abs ( {ψ}_{x} ( i , j ) ) \qquad ( 6 )$$

$${S}_{2} = {\sum }_{( i , j ) ∈ Ω} {ψ}_{x} ( i , j ) \cdot Sign ( {ψ}_{y} ( i , j ) )$$

$${S}_{3} = {\sum }_{( i , j ) ∈ Ω} θ ( i , j ) \cdot Sign ( {ψ}_{x} ( i , j ) )$$

$${S}_{4} = {\sum }_{( i , j ) ∈ Ω} Abs ( {ψ}_{y} ( i , j ) )$$

$${S}_{5} = {\sum }_{( i , j ) ∈ Ω} θ ( i , j ) \cdot Sign ( {ψ}_{y} ( i , j )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> 1 \qquad ( 7 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> 1$$

$$θ ( i , j ) = ( {I}^{( 1 )} ( i , j ) >> {n}_{b} ) - ( {I}^{( 0 )} ( i , j ) >> 4 )$$

where Ω is a 6×6 window around the 4×4 subblock and >> represents a right shift operation.

The motion refinement (vₓ, v_{y}) is then derived using the cross-correlation and auto-correlation terms using the following equations:

$${v}_{x} = {S}_{1} > 0 ? Clip 3 ( - {th}_{BIO}^{′} , {th}_{BIO}^{′} , - ( ( {S}_{3} \cdot 4 ) >> ⌊ {log}_{2} {S}_{1} ⌋ ) ) : 0 \qquad ( 8 )$$

$${v}_{y} = {S}_{4} > 0 ? Clip 3 ( - {th}_{BIO}^{′} , {th}_{BIO}^{′} , - ( ( {S}_{5} \cdot 4 - {v}_{x} {S}_{2} / 2 ) >> ⌊ {log}_{2} {S}_{4} ⌋ ) ) : 0$$

where th′_{BIO}=15, └⋅┘ is a floor function and << represents a left shift operation, and >> represents a right shift operation.

The function x?y:z in equation (8) may be defined as follows:

$$x ? y : z = \{ \begin{matrix}y & if x is true \\ z & otherwise\end{matrix} \qquad ( 9 )$$

The function Clip3(x,y,z) in the equation (8) may be defined as follows:

$$Clip 3 ( x , y , z ) = \{ \begin{matrix}x & z < x \\ y & z > y \\ z & otherwise\end{matrix} \qquad ( 10 )$$

Based on the motion refinement and the gradients, the following adjustment is calculated for each sample in the 4×4 subblock:

$$b ( i , j ) = {v}_{x} ( \frac{\partial {I}^{( 1 )} ( i , j )}{\partial x} - \frac{\partial {I}^{( 0 )} ( i , j )}{\partial x} ) + {v}_{y} ( \frac{\partial {I}^{( 1 )} ( i , j )}{\partial y} - \frac{\partial {I}^{( 0 )} ( i , j )}{\partial y} ) \qquad ( 11 )$$

Finally, the prediction samples pred_{BDOF} of the CU after BDOF is applied are calculated by adjusting the bi-prediction samples as follows:

pred_{BDOF}(i,j)=(I⁽⁰⁾(i,j)+I⁽¹⁾(i,j)+b(i,j)+o_{offset})>>shift (12)

where shift and o_{offset} are a right shift value and an offset value that are applied to combine the L0 and L1 prediction signals I⁽⁰⁾(i,j) and I⁽¹⁾(i,j) for bi-prediction, and are equal to 15-bitDepth and 1<<(14-bitDepth)+2·(1<<13), respectively, << represents a left shift operation, and >> represents a right shift operation.

Based on the above bit-depth control method, it is guaranteed that the maximum bit depth of the intermediate parameters of the whole BDOF process does not exceed 32-bit and the largest input to the multiplication is within 15-bit, i.e., one 15-bit multiplier is sufficient for BDOF implementations.

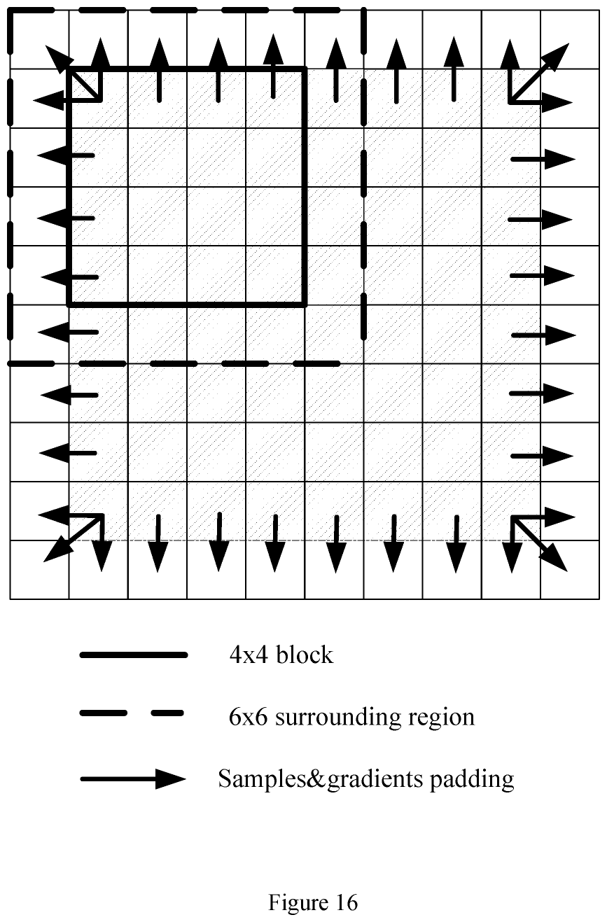

In order to derive the gradient values, some prediction samples I^{(k)}(i,j) in list k (k=0,1) outside of the current CU's boundaries need to be generated. As depicted in FIG. 16, the BDOF in VVC uses an extended area (white positions) including one extended row/column around each of the CU's boundaries. In order to control the computational complexity of generating the out-of-boundary prediction samples, prediction samples in the extended area are generated by taking reference samples at the nearby integer positions (using floor( ) operation on the coordinates) directly without interpolation, and a normal 8-tap motion compensation interpolation filter is used to generate prediction samples within the CU (gray positions). These extended sample values are used in gradient calculation only. For the remaining steps in the BDOF process, if any sample and gradient values outside of the CU's boundaries are needed, they are padded (i.e., repeated) from their nearest neighbors.

When a width and/or a height of a CU are larger than 16 luma samples, it will be split into subblocks each with a width and/or a height equal to 16 luma samples, and the subblock's boundaries are treated as the CU's boundaries in the BDOF process. A maximum unit size for BDOF process is limited to 16×16. For each subblock, the BDOF process may be skipped. When both the BDOF and the DMVR are applied to the current CU, a Sum of Absolute Difference (SAD) between initial L0 and L1 prediction samples is smaller than a threshold, the BDOF process is not applied to one subblock. The threshold is set equal to 2*W*H, where W indicates a width of the subblock, and H indicates a height of the subblock. To avoid the additional complexity of SAD calculation, the SAD between the initial L0 and L1 prediction samples calculated in DMVR process may be re-used here.

If the BCW weight index indicates unequal weights, then BDOF is disabled. Similarly, if WP is enabled for the current block, then BDOF is also disabled. When a CU is coded with symmetric MVD mode or CIIP mode, BDOF is also disabled.

### PROF

Subblock-based affine motion compensation can save memory access bandwidth and reduce computation complexity compared to pixel-based motion compensation, at the cost of prediction accuracy penalty. To achieve a finer granularity of motion compensation, PROF is used in VVC to refine the subblock-based affine motion compensated prediction without increasing the memory access bandwidth for motion compensation. In VVC, after the subblock-based affine motion compensation is performed, a luma prediction sample is refined by adding a difference (i.e., a luma prediction refinement) derived by an optical flow equation thereto. The PROF is described as the following four steps:
Step 1) The subblock-based affine motion compensation is performed to generate subblock prediction I(i,j).
Step 2) Spatial gradients gₓ(i,j) and g_{y}(i,j) of the subblock prediction are calculated at each sample position (i,j) using a 3-tap filter [−1, 0, 1]. The gradient calculation is exactly the same as gradient calculation in BDOF.

gₓ(i,j)=(I(i+1,j)>>shift1)−(I(i−1,j)>>shift1) (13)

g_{y}(i,j)=(I(i,j+1)>>shift1)−(I(i,j−1)>>shift1) (14)
where shift1 is used to control the gradient's precision, and >> represents a right shift operation. The subblock (i.e., having a size of 4×4) prediction is extended by one sample on each side for the gradient calculation. To avoid additional memory bandwidth and additional interpolation computation, those extended samples on extended borders are copied from the nearest integer pixel position in a reference picture.
Step 3) The luma prediction refinement is calculated by the following optical flow equation:

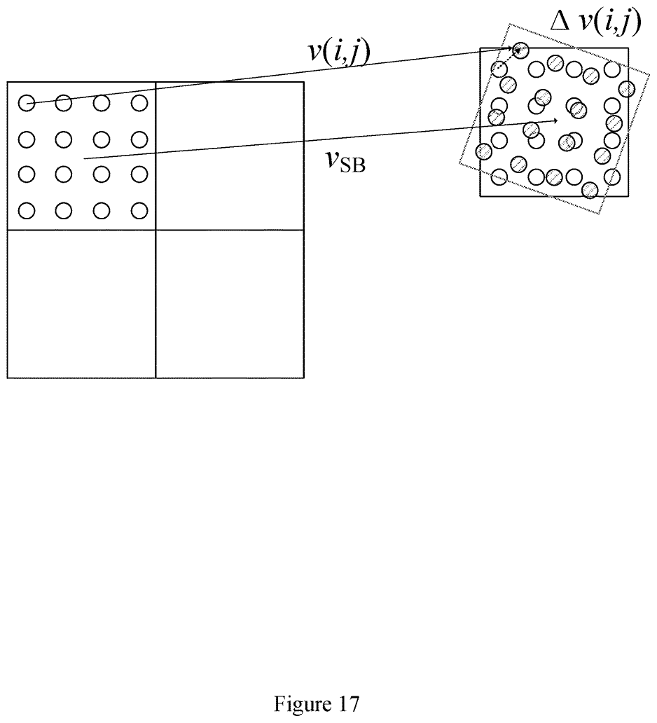

ΔI(i,j)=gₓ(i,j)*Δvₓ(i,j)+g_{y}(i,j)*Δv_{y}(i,j) (15)
where Δv(i,j) is a difference between a MV v(i,j) of a sample located at a position (i,j) and a MV v_{SB} of a subblock to which the sample belongs, as shown in FIG. 17. Δv(i,j) is quantized in unit of 1/32 luma sample precision.

Since affine model parameters and the position of the sample relative to a center of the subblock are not changed from subblock to subblock, Δv(i,j) may be calculated for a first subblock, and reused for other subblocks in the same CU. Let dx(i,j) and dy(i,j) be horizontal and vertical offsets from the position (i,j) of the sample to the center (x_{SB}, y_{SB}) of the subblock, Δv(i,j) may be derived by using the following equation:

$$\{ \begin{matrix}dx ( i , j ) = i - {x}_{SB} \\ dy ( i , j ) = j - {y}_{SB}\end{matrix} \qquad ( 16 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 17 )$$

In order to keep accuracy, the center (x_{SB},y_{SB}) of the subblock is calculated as ((W_{SB}−1)/2, (H_{SB}−1)/2), where W_{SB} and H_{SB} are a width and a height of the subblock, respectively; and C, D, E and F are the affine model parameters, and are calculated as follows.

For a 4-parameter affine model, the affine model parameters are derived by using the following equation:

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 18 )$$

where (V₀ₓ, V_{0y}) and (v₁ₓ,v_{1y}) are top-left and top-right control point motion vectors respectively, and w is a width of the CU.

For a 6-parameter affine model, the affine model parameters are derived by using the following equation:

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 19 )$$

where (v₀ₓ, v_{0y}), (v₁ₓ, v_{1y}) and (v₂ₓ, v_{2y}) are top-left, top-right and bottom-left control point motion vectors respectively, w and h are a width and a height of the CU.
Step 4) Finally, the luma prediction refinement ΔI(i,j) is added to the subblock prediction I(i,j) to generate a final prediction I′(i,j) by using the following equation:

I′(i,j)=I(i,j)+ΔI(i,j) (20)

PROF is not be applied in two cases for an affine coded CU: 1) all control point MVs are the same, which indicates that the CU only has translational motion; and 2) the subblock-based affine Motion Compensation (MC) is degraded to CU-based MC to avoid large memory access bandwidth requirement.

A fast encoding method is applied to reduce the encoding complexity of affine motion estimation with PROF. PROF is not applied at an affine motion estimation stage in following two situations: a) if this CU is not a root block and its parent block does not select the affine mode as its best mode, PROF is not applied since the possibility for the current CU to select the affine mode as its best mode is low; b) if magnitude of the four affine model parameters (C, D, E, F) are all smaller than a predefined threshold and the current picture is not a low delay picture, PROF is not applied because the improvement introduced by PROF is small for this case. In this way, the affine motion estimation with PROF can be accelerated.

### DMVR

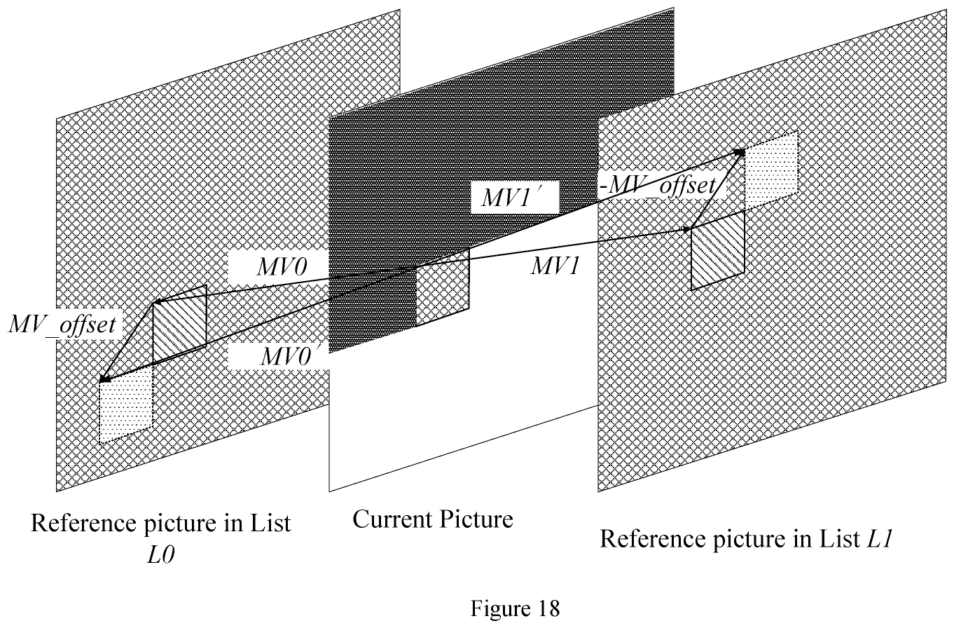

In order to increase the accuracy of MVs in the merge mode, a Bilateral-Matching (BM) based decoder side motion vector refinement is applied in VVC. In a bi-prediction operation, a pair of refined MVs is searched around initial MVs for L0 and L1 reference pictures. The BM method calculates a distortion between prediction samples of two candidate blocks for the L0 and L1 reference pictures. As illustrated in FIG. 18, an SAD between prediction samples of dotted blocks based on each pair of MV candidates (MV0′ and MV1′) around the initial MVs (MV0 and MV1) is calculated. A pair of MV candidates with the lowest SAD becomes the pair of refined MVs and is used to generate a bi-predicted signal.

In VVC, the application of DMVR is restricted and is only applied for CUs which are coded with the following modes or having the following features:
CU-level merge mode with bi-prediction MV;
One reference picture is in the past and the other reference picture is in the future with respect to the current picture;
Distances (i.e. POC differences) from the two reference pictures to the current picture are the same;
Both reference pictures are short-term reference pictures;
The CU has more than 64 luma samples;
Both a height and a width of the CU are larger than or equal to 8 luma samples;
The BCW weight index indicates equal weights;
WP is not enabled for the current block; and
CIIP mode is not used for the current block.

The pair of refined MVs derived by the DMVR process is used to generate the inter prediction samples and is also used in temporal motion vector prediction for coding future pictures. While the initial MVs are used in a deblocking process and are also used in spatial motion vector prediction for future CU coding.

In DMVR, the search points are surrounding the initial MVs and MV offsets between a pair of candidate MVs and the pair of initial MVs obey the MV difference mirroring rule. In other words, any points that are checked by DMVR, denoted by a candidate MV pair (MV0′, MV1′) obey the following two equations:

MV0′=MV0+MV_offset (21)

MV1′=MV1−MV_offset (22)
where MV_offset represents a refinement offset between an initial MV and a candidate MV for one of the reference pictures. The refinement search range is two integer luma samples from the initial MV. The searching includes an integer sample offset search stage and a fractional sample refinement stage.

In the integer sample offset search stage, 25-point full search is applied for integer sample offset searching. An SAD for the pair of initial MVs is firstly calculated. If the SAD for the pair of initial MVs is smaller than a threshold, the integer sample offset search stage of DMVR is terminated. Otherwise, SADs for remaining 24 points are calculated and checked in a raster scanning order. A point with the smallest SAD is selected as an output of the integer sample offset searching stage. To reduce the penalty of the uncertainty of DMVR refinement, it is proposed to favor the pair of initial MVs during the DMVR process. The SAD between prediction samples of the reference blocks referred by the pair of initial MVs is decreased by ¼ of an SAD value which is calculated in the above manner.

The integer sample offset searching is followed by fractional sample refinement. To save the calculational complexity, the fractional sample refinement is derived by using a parametric error surface equation, instead of additional searching with SAD comparison. The fractional sample refinement is conditionally invoked based on the output of the integer sample offset searching stage. When the integer sample offset searching stage is terminated with a center having the smallest SAD in either the first iteration search or the second iteration search, the fractional sample refinement is further applied.

In parametric error surface based sub-pixel offset estimation, an SAD value at the center and SAD values at four neighboring positions from the center are used to fit a 2-dimensional parabolic error surface equation as follows:

E(x,y)=A(x−xₘᵢₙ)²+B(y−yₘᵢₙ)²+C (23)
where E(x,y) represents an SAD value of a sample at a position (x,y), (xₘᵢₙ, yₘᵢₙ) corresponds to a fractional position with a minimum SAD value, A and B are constants, and C corresponds to the minimum SAD value. By solving the above equation using the SAD values of the five search points, (xₘᵢₙ, yₘᵢₙ) is computed as:

xₘᵢₙ=(E(−1,0)−E(1,0))/(2(E(−1,0)+E(1,0)−2E(0,0))) (24)

yₘᵢₙ=(E(0,−1)−E(0,1))/(2((E(0,−1)+E(0,1)−2E(0,0))) (25)

The computed fractional (xₘᵢₙ, yₘᵢₙ) are added to the integer refinement MVs to get sub-pixel accurate refinement MVs.

### GPM

In VVC, GPM is supported for inter prediction. The GPM is signalled using a CU-level flag as one kind of merge mode, with other merge modes including the regular merge mode, the MMVD mode, the CIIP mode and the subblock merge mode. A total of 64 partitions are supported by GPM for each possible CU size W×H (W=2^{m} and H=2ⁿ, with m, n∈{3, 4, 5, 6}) excluding 8×64 and 64×8.

When the GPM is used, a CU is split into two parts by a geometrically located straight line. The position of the splitting line is mathematically derived from angle and offset parameters of a specific partition. Each part of the CU obtained by the geometrical partitioning is inter-predicted using its own motion; and only uni-prediction is allowed for each partition, that is, each part has one motion vector and one reference index. The uni-prediction motion constraint is applied to ensure that like the conventional bi-prediction, only two motion compensated predictions are needed for each CU.

If the GPM is used for the current CU, then a geometric partition index indicating a partition mode of the geometric partitioning (indicating an angle and an offset of the geometric partitioning), and two merge indexes (one for each partition) are further signalled.

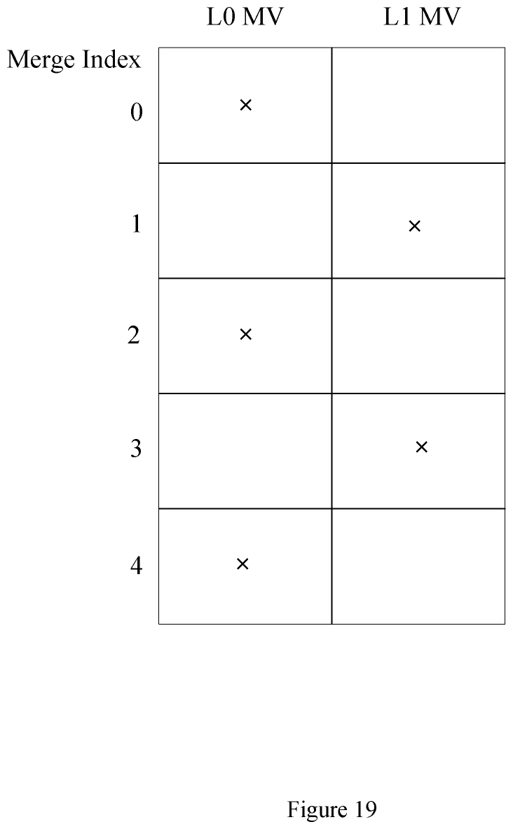

An uni-prediction candidate list is derived directly from a merge candidate list constructed according to the extended merge prediction process described above. Denote n as an index of a uni-prediction motion vector in the uni-prediction candidate list. An LX motion vector of an n^{th} merge candidate in the merge candidate list, with X equal to a parity of n, is used as the n^{th} uni-prediction motion vector for the GPM. These motion vectors are marked with “x” in FIG. 19. In a case that a corresponding LX motion vector of the n^{th} merge candidate in the merge candidate list does not exist, an L (1-X) motion vector of the same merge candidate is used instead as the uni-prediction motion vector for the GPM.

### CIIP

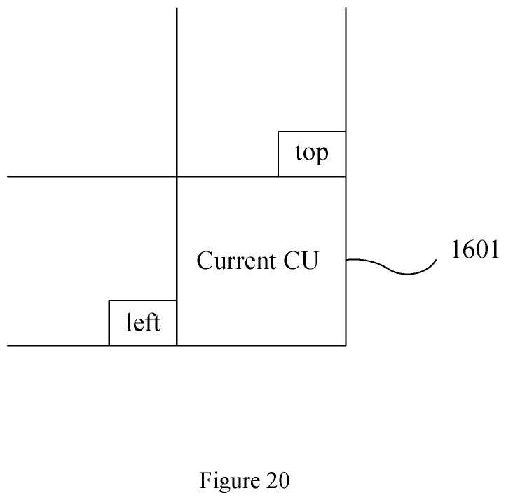

In VVC, when a CU is coded in a merge mode, if the CU contains at least 64 luma samples (that is, a width of CU times a height of the CU is equal to or larger than 64), and if both the width and the height of the CU are less than 128 luma samples, an additional flag is signalled to indicate if a CIIP mode is applied to the current CU. In the CIIP mode, a prediction signal is obtained by combining an inter prediction signal with an intra prediction signal. The inter prediction signal in the CIIP mode is derived using the same inter prediction process as that applied in the regular merge mode; and the intra prediction signal in the CIIP mode is derived following the regular intra prediction process with a planar mode. Then, the intra prediction signal and the inter prediction signal are combined using weighted averaging, where a weight value is calculated depending on coding modes of top and left neighboring blocks of the current CU 1601 (as shown in FIG. 20) as follows:
If the top neighboring block is available and is intra coded, then isIntraTop is set to 1, otherwise isIntra Top is set to 0;
If the left neighboring block is available and is intra coded, then isIntraLeft is set to 1, otherwise isIntraLeft is set to 0;
If (isIntraLeft+isIntra Top) is equal to 2, then the weight value is set to 3;
Otherwise, if (isIntraLeft+isIntraTop) is equal to 1, then the weight value is set to 2;
Otherwise, the weight value is set to 1.
The prediction signal P_{CIIP} in the CIIP mode is derived as follows:

P_{CIIP}=((4−wt)*Pᵢₙₜₑᵣ+wt*Pᵢₙₜᵣₐ+2)>>2 (26)

Where Pᵢₙₜₑᵣ is the inter prediction signal in the CIIP mode, Pᵢₙₜᵣₐ is the intra prediction signal in the CIIP mode, wt is the weight value, and >> represents a right shift operation.

### Decoder Side Intra Mode Derivation (DIMD)

When DIMD is applied, up to five intra modes are derived from the reconstructed neighbor samples, and those five predictors are combined with the planar mode predictor with the weights derived from the histogram of gradients as described in JVET-00449. The division operations in weight derivation are performed utilizing the same lookup table (LUT) based integerization scheme used by the CCLM. For example, the division operation in the orientation calculation

Orient=G_{y}/Gₓ

is computed by the following LUT-based scheme:

X=Floor(Log 2(Gx))

normDiff=((Gx<<4)>>x)& 15

x+=(3+(normDiff!=0)?1:0)

Orient=(Gy*(DivSigTable[normDiff]|8)+(1<<(x−1)))>>x

where

DivSigTable[16]={0,7,6,5,5,4,4,3,3,2,2,1,1,1,1,0}.

For a block of size W×H, the weight for each of the five derived modes is modified if the one the above or left histogram magnitudes is twice larger than the other one. In this case, the weights are location dependent and computed as follows:
If the above histogram is twice the left, then:

$${w}_{i} ( x , y ) = w D i m {d}_{i} + {Δ}_{i} - 2 {Δ}_{i} \frac{y}{( H - 1 )} .$$

If the left histogram is twice the above, then:

$${w}_{i} ( x , y ) = w D i m {d}_{i} + {Δ}_{i} - 2 {Δ}_{i} \frac{x}{( W - 1 )} ,$$

where wDimdᵢ is the unmodified uniform weight of the DIMD selected as in JVET-00449, At is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, note the region of neighboring reconstructed samples used for computing the histogram of gradients is modified compared to JVET-O0449 method, depending on reconstructed samples availability. The region of decoded reference samples of current W×H luma CB is extended towards the above-right side if available, up to W additional columns. It is extended towards the bottom-left side if available, up to H additional rows.

### Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

costMode2<2*costMode1.
If this condition is true, the fusion is applied, otherwise the only model is used.

Weights of the modes are computed from their SATD costs as follows:

weight1=costMode2/(costMode1+costMode2)

weight2=1−weight1

The division operations are conducted using the same lookup table (LUT) based integerization scheme used by the CCLM.

Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

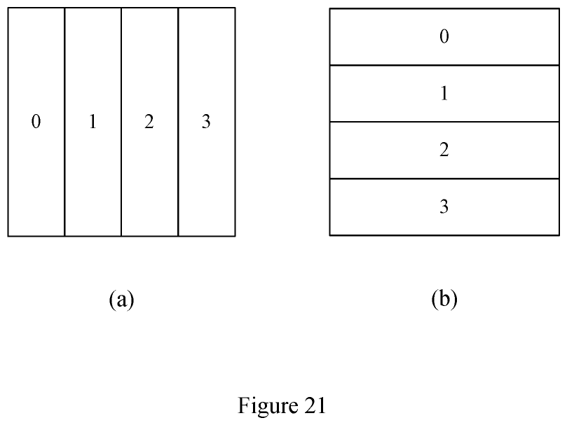

In addition, it is also proposed to modify the weights (wIntra, wInter) for the two tests if the derived intra prediction mode is an angular mode. For near-horizontal modes (2<=angular mode index <34), the current block is vertically divided as shown in FIG. 21 (a); for near-vertical modes (34<=angular mode index <=66), the current block is horizontally divided as shown in FIG. 21 (b).

The (wIntra, wInter) for different sub-blocks are shown in Table 3.

TABLE 3
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CHIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### Geometric Partitioning Mode (GPM) in ECM

GPM with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

GPM with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 4. The motion is then refined by minimizing the difference between the current template and the template in the reference picture using the same search pattern of merge mode with half-pel interpolation filter disabled.

TABLE 4
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

### a GPM Candidate List is Constructed as Follows:

1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

GPM with Inter and Intra Prediction

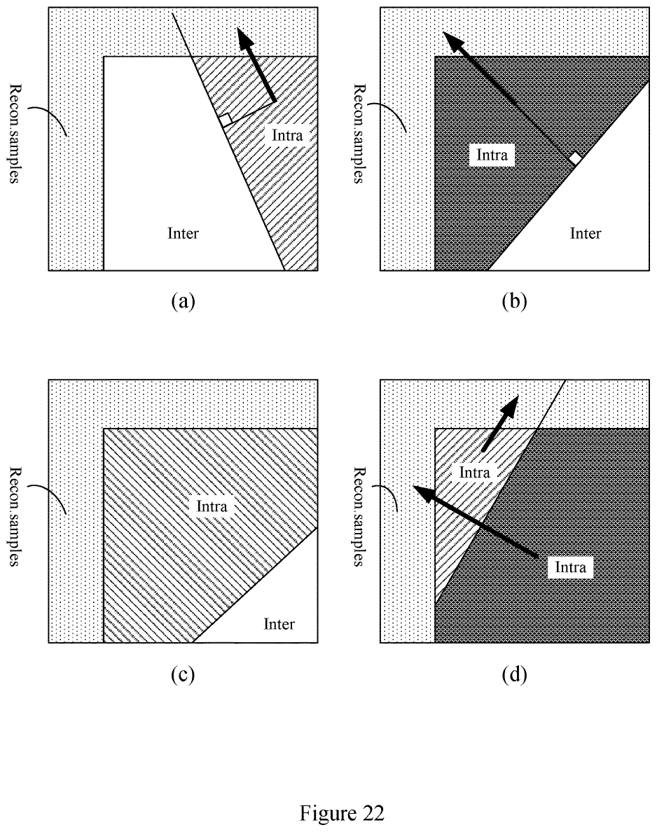

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIG. 22 (a)~(c), respectively. Furthermore, GPM with intra and intra prediction as shown FIG. 22 (d) is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 5, which are already used for GPM with template matching (GPM-TM).

TABLE 5
The position of available neighboring blocks for IPM candidate derivation based on the angle
of GPM block boundary. A and L denotes the above and left side of the prediction block.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighboring blocks.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode is located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 as available split modes.

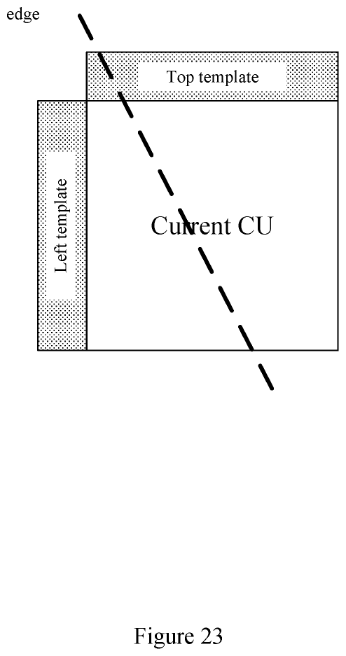

The edge on the template is extended from that of the current CU, as FIG. 23 illustrates, but GPM blending process is not used in the template area across the edge.

After ascending reordering using TM cost, an index is signaled.

Geometric Partitioning Mode (GPM) with Adaptive Blending

In VVC, the final prediction samples are generated with by blending the prediction of the two prediction signals using weighted average. Two integer blending matrices (W0 and W1) are used. The weights in the GPM blending matrices are derived from the ramp function based on the displacement from a predicted sample position to the GPM partitioning boundary. The blending area size is fixed to two (2 samples on each side of the GPM partition split boundary).

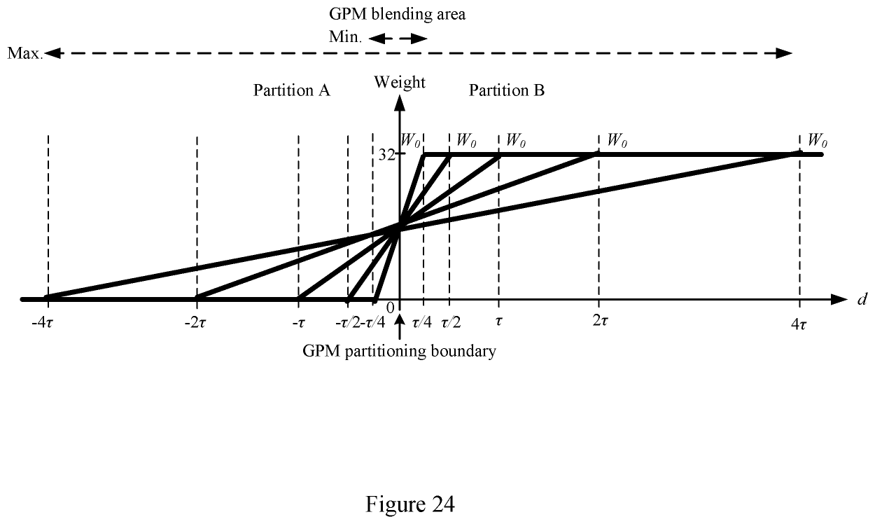

The blending process in ECM is improved by adding four extra blending area sizes (quarter, half, double, and quadruple of the existing area size) as shown in FIG. 24. A CU level flag is coded to signal the selected blending area size. Furthermore, the extended weighting precision is utilized, in which the maximum value of the weighs is changed from 8 (in VVC) to 32 to accommodate the extended blending area sizes.

### Bi-Predictive GPM

The GPM design in VVC relies on uni-predictive motion vectors to generate motion compensated prediction samples for each inter GPM partition. In ECM, such a design has been extended to allow usage of bi-predictive motion vectors.

When constructing a GPM candidate list, the extraction process that extracts uni-predictive motion vectors from the initial merge list is invoked only for small blocks 8×8, 16×8 and 8×16. For larger blocks, the extraction process is bypassed, so the initial merge list (which may contain merged Bi-MVs) is directly used as the final GPM merge list. The generation of the initial merge list is the same as before (i.e., the normal merge list generation without any candidate reordering) except that when generating the initial merge list for larger blocks (i.e., blocks with the extraction process bypassed), the motion vector difference threshold for controlling whether a candidate can be added into the list is increased to be one full sample distance.

BDOF based motion vector refinement as in the multi-pass DMVR is used when generating motion compensated prediction samples.

When GPM-MMVD is used for a GPM partition and its base motion vector is bi-predictive, for low-delay pictures, the signalled MVD is applied on top of the L0 and L1 motion vector as in the existing merge MMVD design. For non-low-delay pictures, the bi-predictive motion vector is converted into a uni-predictive motion vector first and then the MVD is applied on top.

### Spatial Geometric Partitioning Mode (SGPM)

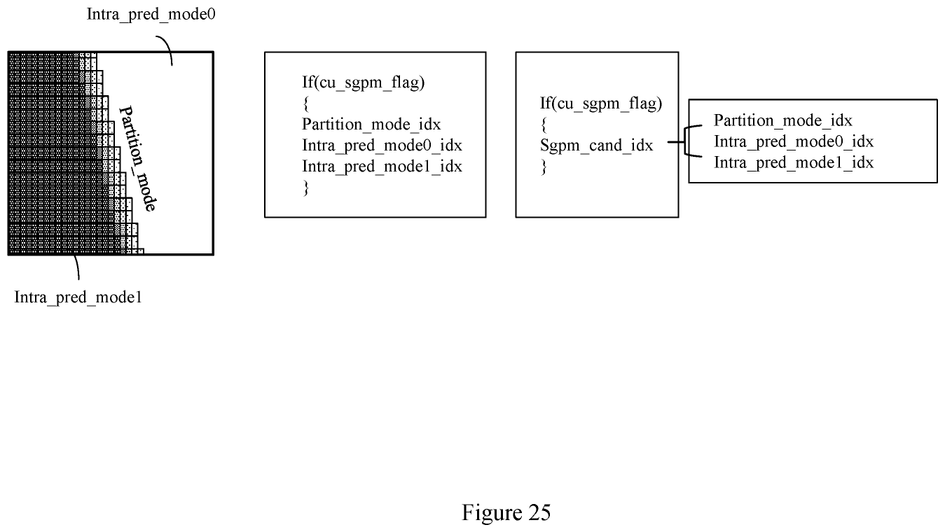

SGPM is an intra mode that resembles the inter coding tool of GPM, where the two prediction parts are generated from intra predicted process. In this mode, a candidate list is built with each entry containing one partition split and two intra prediction modes as shown in FIG. 25. 26 partition modes and 3 of intra prediction modes are used to form the combinations. The length of the candidate list is set equal to 16. The selected candidate index is signalled.

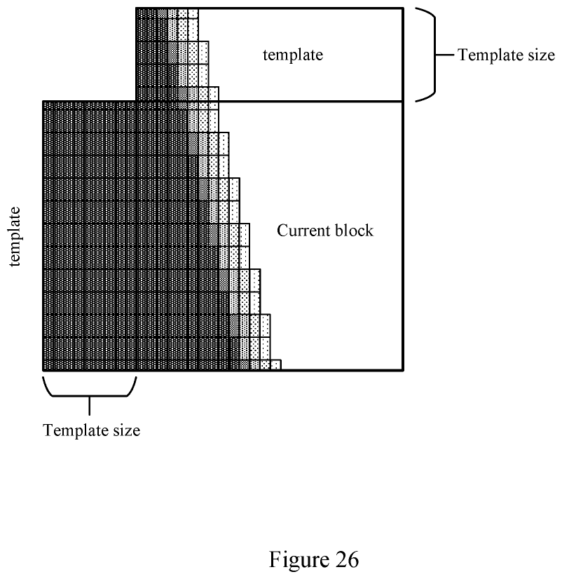

The list is reordered using template (FIG. 26) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

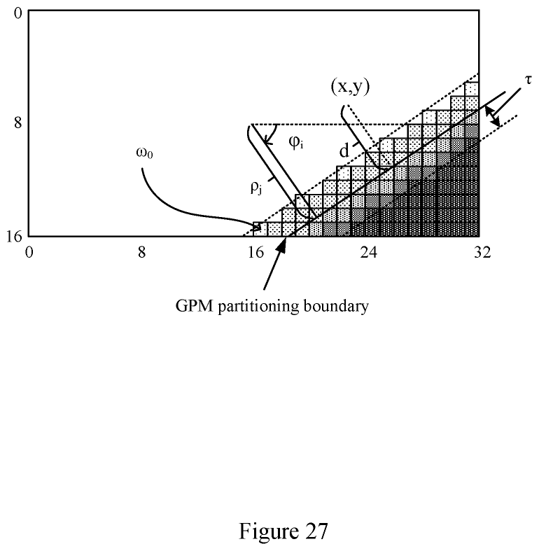

Adaptive blending is also used for spatial GPM, where blending depth t shown in FIG. 27 is derived as follows:
If min (width, height)==4, ½ τ is selected
else if min (width, height)==8, τ is selected
else if min (width, height)==16, 2 τ is selected
else if min (width, height)==32, 4 τ is selected
else, 8 τ is selected

### TM Based Reordering for MMVD and Affine MMVD

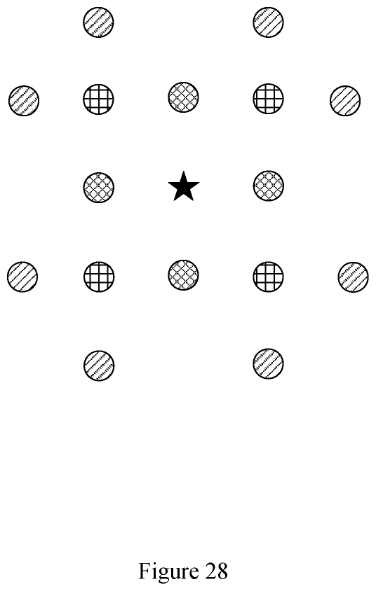

The MMVD offsets are extended for MMVD and affine MMVD modes. Additional refinement positions along k×⅛ diagonal angles are added shown in FIG. 28, thus increasing the number of directions from 4 to 16. Second, based on the SAD cost between the template (one row above and one column left to the current block) and its reference for each refinement position, all the possible MMVD refinement positions (16×6) for each base candidate are reordered. Finally, the top ⅛ refinement positions with the smallest template SAD costs are kept as available positions, consequently for MMVD index coding. The MMVD index is binarized by the rice code with the parameter equal to 2. The affine MMVD reordering is extended, in which additional refinement positions along k×¼ diagonal angles are added. After reordering top ½ refinement positions with the smallest template SAD costs are kept.

The first N motion candidates in the candidate list before being reordered are utilized as the base candidates for MMVD and affine MMVD. N is equal to 3 for MMVD, and [1, 3] depending on the neighboring block affine flags for affine MMVD. Two ways of adding MMVD offsets are allowed, including the ‘two-side’ and ‘one-side’, depending on whether the offset of the other reference picture list is mirrored or directly set to zero. Which way is applied to one block is dependent on the TM cost.

IBC with Geometry Partitioning

Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 6
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 7
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

In bi-predictive IBC GPM, two flags are signalled to indicate the prediction modes of two partitions, the first flag indicates whether the first partition is intra predicted, and if not then the second flag is signalled to indicate whether intra prediction is used for the second partition. This method is applied to SCC only.

### Problem Statement

Currently, the prediction mode indexes of two partitions and split mode index are separately reordered with template matching methods in GPM with inter and inter prediction, GPM with inter and intra prediction, GPM with inter and IBC prediction, GPM with inter and Intra TMP prediction, it is straightforward to combine the prediction mode indexes of two partitions and split mode index together and jointly reorder them similar to the implementation of SGPM, which may save the bits overhead and improve the coding performance.

### Proposed Methods

In this disclosure, to address the issues as pointed out in the “problem statement” section, methods are provided to further improve the existing design of the GPM. In general, the main features of the proposed technologies in this disclosure are summarized as follows.

The split modes and the two prediction modes of GPM are jointly reordered with template matching methods, where one prediction mode is inter mode, and the other prediction mode can be inter mode, intra mode, IBC mode, or Intra TMP mode.

It is noted that the disclosed methods may be applied independently or jointly.

### Template Matching Based Jointly Reordering for GPM Split Modes and Prediction Modes

According to one or more embodiments of the disclosure, the split modes and the two prediction modes of GPM are jointly reordered with template matching methods, where one prediction mode is inter mode, and the other prediction mode can be inter mode, intra mode, IBC mode, or Intra TMP mode. Different methods may be used to achieve this goal.

In the first method, a candidate list is built with each entry containing one partition split and two prediction modes. In the two prediction modes of the GPM two partitions, one prediction mode is inter mode and the other prediction mode can be inter mode, intra mode, IBC mode, and Intra TMP mode.

For the derivation of partition split, different GPM split modes can be utilized. In one example, 26 split modes as used in SGPM are utilized. In another example, 64 split modes as used in GPM with inter and inter prediction are utilized.

For the derivation of prediction mode, if the prediction mode is intra mode, different intra mode candidate list derivation methods can be utilized. In one example, the intra prediction mode candidate list derivation methods as used in SGPM are utilized, where the parallel mode, TIMD horizontal mode, TIMD vertical mode, DIMD mode, and intra prediction modes of adjacent spatial blocks are successively scanned, and the first 3 intra prediction modes are saved in the final intra prediction mode candidate list. In another example, the intra prediction mode candidate list derivation methods as used in GPM with inter and intra prediction are utilized, where the parallel mode, TIMD mode, DIMD mode, and intra prediction modes of adjacent spatial blocks are successively scanned, and the first 3 intra prediction modes are saved in the final intra prediction mode candidate list.

If the prediction mode is IBC mode or Intra TMP mode, different IBC or Intra TMP block vector candidate list derivation methods can be utilized. In one example, the adjacent spatial blocks and non-adjacent spatial blocks are successively scanned, if one block is IBC coded or Intra TMP coded and the block vector of the block is different from all the block vectors in the initial block vector candidate list, the block vector of the block is added into the initial block vector candidate list. Different block vector precisions can be utilized. In one example, fractional block vectors are utilized. In another example, integer block vectors are utilized. After obtaining the initial block vector candidate list, the block vectors can be reordered with template matching methods, and only several block vectors with the smallest template matching costs are added into the final block vector candidate list. For example, the block vectors in the initial block vector candidate list are reordered using the metric of SAD between the prediction and reconstruction of template, and only the 2 block vectors with the smallest SAD are added into the final block vector candidate list.

If the prediction is inter mode, different motion vector candidate list derivation methods can be utilized. In one example, the motion vector candidate list contains only uni-predictive motion vector. Different methods can be utilized to achieve this goal. For example, after constructing a regular merge candidate list, the initial motion vector candidate list is derived as follows: First, interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates. Second, interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates. After obtaining the initial motion vector candidate list, different methods can be utilized to obtain the final motion vector candidate list. In one example, the uni-predictive motion vectors in the initial motion vector candidate list can be reordered with template matching methods, and only several uni-predictive motion vectors with the smallest template matching costs are added into the final motion vector candidate list. For example, the uni-predictive motion vectors in the initial motion vector candidate list are reordered using the metric of SAD between the prediction and reconstruction of template, and only the 3 uni-predictive motion vectors with the smallest SAD are added into the final motion vector candidate list. In another example, only several uni-predictive motion vectors at the front of the initial motion vector candidate list are added into the final motion vector candidate list. For example, only the 3 uni-predictive motion vectors at the front of the initial motion vector candidate list are added into the final motion vector candidate list.

In another example, the motion vector candidate list contains both uni-predictive and bi-predictive motion vectors. Different methods can be utilized to achieve this goal. For example, after constructing a regular merge candidate list, this candidate list is directly used as the initial motion vector candidate list, as the regular merge candidate list may contain both uni-predictive and bi-predictive motion vectors. After obtaining the initial motion vector candidate list, different methods can be utilized to obtain the final motion vector candidate list. In one example, the uni-predictive or bi-predictive motion vectors in the initial motion vector candidate list can be reordered with template matching methods, and only several uni-predictive or bi-predictive motion vectors with the smallest template matching costs are added into the final motion vector candidate list. For example, the uni-predictive or bi-predictive motion vectors in the initial motion vector candidate list are reordered using the metric of SAD between the prediction and reconstruction of template, and only the 3 uni-predictive or bi-predictive motion vectors with the smallest SAD are added into the final motion vector candidate list. In another example, only several uni-predictive or bi-predictive motion vectors at the front of the initial motion vector candidate list are added into the final motion vector candidate list. For example, only the 3 uni-predictive or bi-predictive motion vectors at the front of the initial motion vector candidate list are added into the final motion vector candidate list.

It should be noted that the inter mode can be regular inter mode or affine inter mode. When the inter mode is regular inter mode, the motion vector candidate list contains translational motion vectors. When the inter mode is affine inter mode, the motion vector candidate list contains control point motion vectors.

After building a candidate list with each entry containing one partition split and two prediction modes, the candidate list can be reordered with template matching methods, and only several candidates with the smallest template matching costs are saved. For example, the candidates in the candidate list are reordered using the metric of SAD between the prediction and reconstruction of template, and only the 16 candidates with the smallest SAD are saved. After that, the selected candidate index is signalled into bit stream. More specifically, the selected candidate index is chosen from the saved 16 candidates with an RDO process in encoder and signalled into bit stream. After decoder received the signalled candidate index, the corresponding partition split and two prediction modes can be obtained from the same reordered candidate list. Then the GPM prediction samples can be generated with the obtained partition split and two prediction modes. It should be noted that when the prediction mode in the candidate is bi-predictive inter mode, BDOF based motion vector refinement as in the multi-pass DMVR can used when generating motion compensated prediction samples.

In the proposed “Template matching based reordering for GPM split modes and prediction modes”, different adaptive blending methods can be used. In one example, same to the adaptive blending in SGPM, the blending depth is derived as follows: If min (width, height)==4, ½ τ is selected; else if min (width, height)==8, τ is selected; else if min (width, height)==16, 2 τ is selected; else if min (width, height)==32, 4 τ is selected; else, 8 τ is selected. In another example, same to the adaptive blending in GPM with inter and inter mode, the chosen blending index is signalled into bit stream.

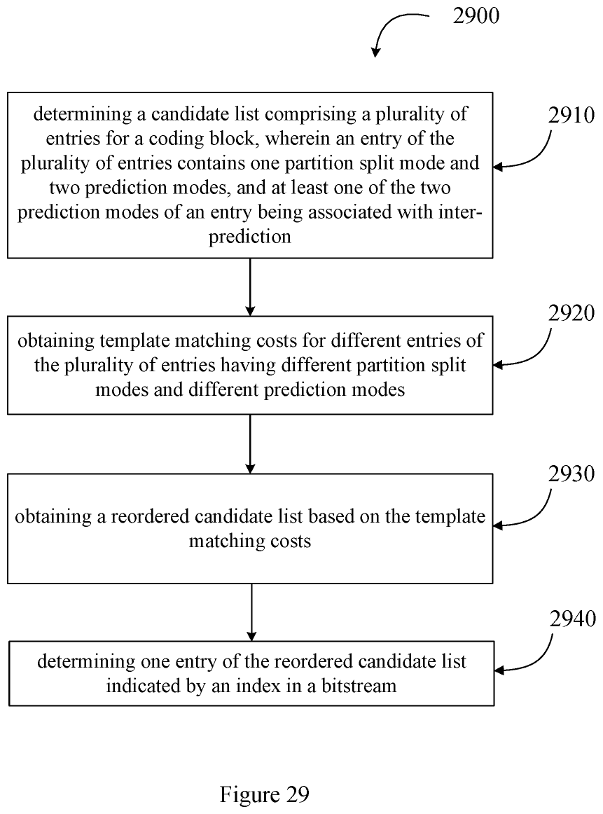

FIG. 29 illustrates a workflow of a method 2900 for decoding video data according to one or more aspects of the present disclosure. The method 2900 may be performed at a decoder, e.g., video decoder 30 with reference to FIG. 1 and FIG. 3. The decoder may perform similar processes as an encoder to generate and reorder a candidate list for a current coding block, comprising at block 2910, a candidate list comprising a plurality of entries may be generated for a current coding block, an entry of the plurality of entries contains one partition split mode indicative of a partition of the coding block into two partitions and two prediction modes to be used for the two divided partitions of the coding block respectively. For example, the candidate list may be built with each entry of the candidate list corresponding to one of a plurality of combinations of different partition split modes and different pairs of prediction modes. At least one of a pair of prediction modes of an entry of the candidate list is associated with inter-prediction.

As illustrated above, different partition split modes may be used for building the candidate list. For example, 26 split modes as used in SGPM and/or 64 split modes as used in GPM with inter and inter prediction and/or 48 split modes as used in IBC with geometry partitioning (e.g., IBC-GPM) may be utilized. In another example, any combination of one or more of current split modes and/or other split modes beyond the current split modes may be utilized for building the candidate list.

As further illustrated above, one or more of inter-prediction, intra-prediction, intra block copy (IBC) prediction, or intra template matching prediction (TMP) may be considered when building the candidate list for the current coding block. Accordingly, variable methods may be utilized to obtain block vector candidates, motion vector candidates, and/or intra-prediction candidates that may be served as prediction modes indicating how to generate a prediction for a current coding block and/or a partition of the current coding block.

In an aspect of the present disclosure, at least one of the two prediction modes of an entry of the candidate list is associated with inter-prediction, providing an improvement in a variety of GPM application scenarios, such as GPM with inter and inter prediction, GPM with inter and intra prediction, GPM with inter and IBC prediction, GPM with inter and Intra TMP prediction, by leveraging a headroom on efficiency of template matching based reordering associated with inter-prediction.

In another aspect of the present disclosure, different partition split modes (e.g., different sets of partition split modes) may be used when utilizing different pairs of prediction modes. For example, when building the candidate list, a proper combination of one partition split mode and a pair of prediction modes may be determined for an entry of the candidate list.

For example, an entry of a candidate list may be formed from one of a set of 64 split modes as used in GPM with inter and inter prediction (e.g., the two partitions of the current coding block are both coded with inter-prediction) and a pair of motion vector candidates. The motion vector candidates may be derived from uni-predictive motion vectors or bi-predictive motion vectors (e.g., a regular merge candidate list), translational motion vectors, and/or control point motion vectors.

For another example, an entry of a candidate list may be formed from one of another set of split modes as used in GPM with inter and intra prediction (e.g., the two partitions of the current coding block are coded with inter-prediction and intra-prediction respectively) and a pair of a motion vector candidate and an intra-prediction candidate. The motion vector candidate and the intra-prediction candidate may be derived according to various approaches as described above.

For another example, a candidate list may be built for each of GPM with inter and inter prediction, GPM with inter and intra prediction, GPM with inter and IBC prediction, or GPM with inter and Intra TMP prediction or the like. That is, the reordering may be performed individually within each of candidate lists specific to one of different GPM application scenarios. Alternatively or additionally, a candidate list may be built for two or more of GPM with inter and inter prediction, GPM with inter and intra prediction, GPM with inter and IBC prediction, or GPM with inter and Intra TMP prediction or the like, such that the reordering can be performed jointly for different GPM application scenarios, and the efficiency may be further improved.

At block 2920, template matching costs may be derived for respective entries of the plurality of entries. These entries may have different partition split modes and/or different pairs of prediction modes. In other words, the derived template matching costs can be compared with each other from both partition and prediction perspectives. Thus, the reordering of the candidate list can be more efficient to improve the coding efficiency.

For example, a first entry of the candidate list may have a first partition split mode (e.g., angle 1, offset 1) and a first and second prediction modes, and a second entry of the candidate list may have a second partition split mode (e.g., angle 2, offset 2) and a third and fourth prediction modes. At least one of the first partition split mode, the first prediction mode or the second prediction mode of the first entry is different from the corresponding one of the second partition split mode, the third prediction mode or the fourth prediction mode of the second entry. In an example of GPM with inter and inter prediction, the first partition split mode may be different from or same as the second partition split mode, and the first, second, third, and fourth prediction modes correspond to four different motion vector candidates respectively, or at least one of the first or second prediction mode corresponds to a motion vector candidate that is different from a motion vector candidate for the third or fourth prediction mode. In another example of GPM with inter and inter prediction, the candidate list may include a third entry, a third partition split mode of the third entry is different from the second partition split mode of the second entry, and a fifth prediction mode of the third entry may correspond to a same motion vector candidate as the third prediction mode of the second entry, and a sixth prediction mode of the third entry may correspond to a same motion vector candidate as the fourth prediction mode of the second entry.

At block 2930, the candidate list may be reordered based on a comparison of the derived template matching costs. For example, first 16 (or other number of) entries of the reordered candidate list with less template matching costs may be saved. In another example, more or less number of entries may be saved in consideration of a trade off between an accuracy and a reduced signalling overhead.

At block 2940, the decoder may use an index received from a video bitstream to determine which one of entries of the reordered candidate list is the entry selected by the encoder. For example, a decoding process of the current coding block may be based on the indicated entry comprising a partition split mode and a pair of prediction modes. For example, based on the indicated entry, corresponding two predictions of the two partitions may be obtained. The predictions may be based on inter-prediction, intra-prediction, intra block copy (IBC) prediction, or intra template matching prediction (TMP) as indicated by the pair of prediction modes of the indicated entry. The two predictions of the two partitions may be combined to obtain a prediction of the video block with or without adaptive blending as described above.

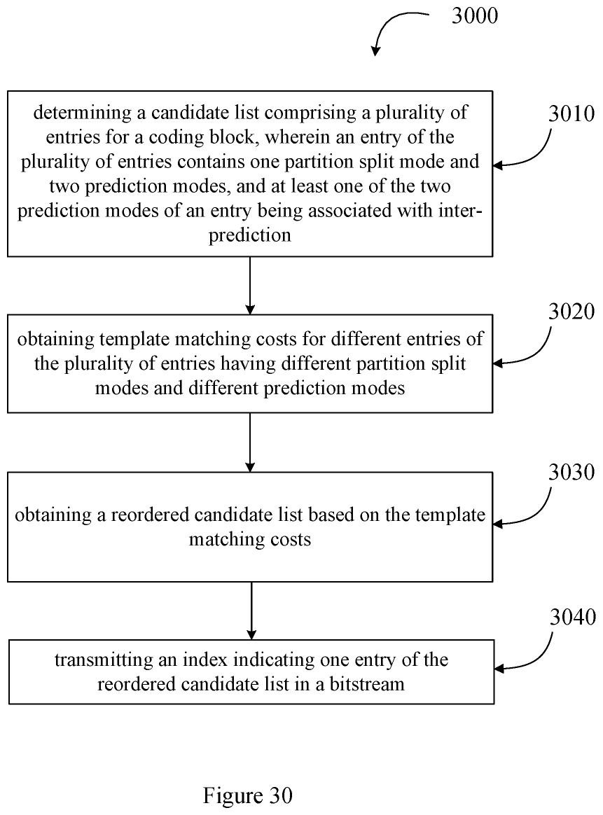

FIG. 30 illustrates a workflow of a method 3000 for encoding video data according to one or more aspects of the present disclosure. The method 3000 may be performed at an encoder, e.g., video encoder 20 with reference to FIG. 1 and/or FIG. 2. At block 3010, a candidate list comprising a plurality of entries may be generated for a current video block (e.g., a coding block), an entry of the plurality of entries contains one partition split mode indicative of a partition of the coding block into two partitions and two prediction modes to be used for the two partitions respectively. For example, the candidate list may be built with each entry of the candidate list corresponding to one of a plurality of combinations of different partition split modes and different pairs of prediction modes.

As illustrated above, different partition split modes may be used for building the candidate list. For example, 26 split modes as used in SGPM and/or 64 split modes as used in GPM with inter and inter prediction and/or 48 split modes as used in IBC with geometry partitioning (e.g., IBC-GPM) may be utilized. In another example, any combination of one or more of current split modes and/or other split modes beyond the current split modes may be utilized for building the candidate list.

As further illustrated above, one or more of inter-prediction, intra-prediction, intra block copy (IBC) prediction, or intra template matching prediction (TMP) may be considered when building the candidate list for the current coding block. Accordingly, variable methods may be utilized to obtain block vector candidates, motion vector candidates, and/or intra-prediction candidates that may be served as prediction modes indicating how to generate a prediction for a current coding block and/or a partition of the current coding block.

In an aspect of the present disclosure, at least one of the two prediction modes of an entry of the candidate list is associated with inter-prediction, providing an improvement in a variety of GPM application scenarios, such as GPM with inter and inter prediction, GPM with inter and intra prediction, GPM with inter and IBC prediction, GPM with inter and Intra TMP prediction, by leveraging a headroom on efficiency of template matching based reordering associated with inter-prediction.

In another aspect of the present disclosure, different partition split modes (e.g., different sets of partition split modes) may be used when utilizing different pairs of prediction modes. For example, when building the candidate list, a proper combination of one partition split mode and a pair of prediction modes may be determined for an entry of the candidate list.

For example, an entry of a candidate list may be formed from one of a set of 64 split modes as used in GPM with inter and inter prediction (e.g., the two partitions of the current coding block are both coded with inter-prediction) and a pair of motion vector candidates. The motion vector candidates may be derived from uni-predictive motion vectors or bi-predictive motion vectors (e.g., a regular merge candidate list), translational motion vectors, and/or control point motion vectors.

For another example, an entry of a candidate list may be formed from one of another set of split modes as used in GPM with inter and intra prediction (e.g., the two partitions of the current coding block are coded with inter-prediction and intra-prediction respectively) and a pair of a motion vector candidate and an intra-prediction candidate. The motion vector candidate and the intra-prediction candidate may be derived according to various approaches as described above.

For another example, a candidate list may be built for each of GPM with inter and inter prediction, GPM with inter and intra prediction, GPM with inter and IBC prediction, or GPM with inter and Intra TMP prediction or the like. That is, the reordering may be performed individually within each of candidate lists specific to one of different GPM application scenarios. Alternatively or additionally, a candidate list may be built for two or more of GPM with inter and inter prediction, GPM with inter and intra prediction, GPM with inter and IBC prediction, or GPM with inter and Intra TMP prediction or the like, such that the reordering can be performed jointly for different GPM application scenarios, and the efficiency may be further improved.

At block 3020, template matching costs may be derived for respective entries of the plurality of entries. These entries may have different partition split modes and/or different pairs of prediction modes. In other words, the derived template matching costs can be compared with each other in consideration of both partition and prediction perspectives. Thus, the reordering of the candidate list can be more efficient.

For example, a first entry of the candidate list may have a first partition split mode (e.g., angle 1, offset 1) and a first and second prediction modes, and a second entry of the candidate list may have a second partition split mode (e.g., angle 2, offset 2) and a third and fourth prediction modes. At least one of the first partition split mode, the first prediction mode or the second prediction mode of the first entry is different from the corresponding one of the second partition split mode, the third prediction mode or the fourth prediction mode of the second entry. In an example of GPM with inter and inter prediction, the first partition split mode may be different from or same as the second partition split mode, and the first, second, third, and fourth prediction modes correspond to four different motion vector candidates respectively, or at least one of the first or second prediction mode corresponds to a motion vector candidate that is different from a motion vector candidate for the third or fourth prediction mode. In another example of GPM with inter and inter prediction, the candidate list may include a third entry, a third partition split mode of the third entry is different from the second partition split mode of the second entry, and a fifth prediction mode of the third entry may correspond to a same motion vector candidate as the third prediction mode of the second entry, and a sixth prediction mode of the third entry may correspond to a same motion vector candidate as the fourth prediction mode of the second entry.

At block 3030, the candidate list may be reordered based on the comparison of the derived template matching costs. For example, first 16 entries of the reordered candidate list with less template matching costs may be saved. In another example, more or less number of entries may be saved in consideration of a trade off between an accuracy and a reduced signalling overhead.

At block 3040, one of the saved entries of the reordered candidate list may be selected based on a certain metric (e.g., RDO). An index indicative of the selected entry may be transmitted in a video bitstream.

For example, based on the selected entry, corresponding two predictions of the two partitions may be obtained. The predictions may be based on inter-prediction, intra-prediction, intra block copy (IBC) prediction, or intra template matching prediction (TMP) as indicated by the pair of prediction modes of the selected entry. The two predictions of the two partitions may be combined to obtain a prediction of the video block with or without adaptive blending as described above.

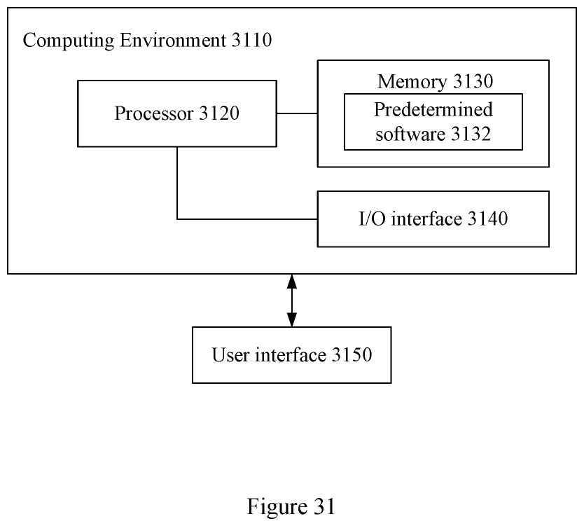

FIG. 31 shows a computing environment 3110 coupled with a user interface 3150. The computing environment 3110 can be part of a data processing server. The computing environment 3110 includes a processor 3120, a memory 3130, and an Input/Output (I/O) interface 3140.

The processor 3120 typically controls overall operations of the computing environment 3110, such as the operations associated with display, data acquisition, data communications, and image processing. The processor 3120 may include one or more processors to execute instructions to perform all or some of the steps in the above-described methods. Moreover, the processor 3120 may include one or more modules that facilitate the interaction between the processor 3120 and other components. The processor may be a Central Processing Unit (CPU), a microprocessor, a single chip machine, a Graphical Processing Unit (GPU), or the like.

The memory 3130 is configured to store various types of data to support the operation of the computing environment 3110. The memory 3130 may include predetermined software 3132. Examples of such data includes instructions for any applications or methods operated on the computing environment 3110, video datasets, image data, etc. The memory 3130 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 3140 provides an interface between the processor 3120 and peripheral interface modules, such as a keyboard, a click wheel, buttons, and the like. The buttons may include but are not limited to, a home button, a start scan button, and a stop scan button. The I/O interface 3140 can be coupled with an encoder and decoder.

In an embodiment, there is also provided a non-transitory computer-readable storage medium comprising a plurality of programs, for example, in the memory 3130, executable by the processor 3120 in the computing environment 3110, for performing the above-described methods. Alternatively, the non-transitory computer-readable storage medium may have stored therein a bitstream or a data stream comprising encoded video information (for example, video information comprising one or more syntax elements) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, the is also provided a computing device comprising one or more processors (for example, the processor 3120); and the non-transitory computer-readable storage medium or the memory 3130 having stored therein a plurality of programs executable by the one or more processors, wherein the one or more processors, upon execution of the plurality of programs, are configured to perform the above-described methods.

In an embodiment, there is also provided a computer program product comprising a plurality of programs, for example, in the memory 3130, executable by the processor 3120 in the computing environment 3110, for performing the above-described methods. For example, the computer program product may include the non-transitory computer-readable storage medium.

In an embodiment, the computing environment 3110 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for decoding video data, comprising:
determining a candidate list comprising a plurality of entries for a video block, wherein an entry of the plurality of entries contains one partition split mode indicative of a partition of the video block into two partitions and two prediction modes for the two partitions, respectively, and at least one of the two prediction modes of an entry is associated with inter-prediction;
obtaining template matching costs for different entries of the plurality of entries having different partition split modes and different prediction modes;
obtaining a reordered candidate list based on the template matching costs; and
determining one entry of the reordered candidate list indicated by an index in a bitstream.

2. The method of claim 1, further comprising:
obtaining a first template matching cost for a first entry of the plurality of entries having a first partition split mode and a first and second prediction modes; and
obtaining a second template matching cost for a second entry of the plurality of entries having a second partition split mode and a third and fourth prediction modes,
wherein the reordered candidate list is obtained by reordering the first and second entries based on a comparison of the first template matching cost and the second template matching cost.

3. The method of claim 1, wherein the two prediction modes of the entry are associated with inter-prediction and a member of a group including at least one of inter-prediction, intra-prediction, intra block copy (IBC) prediction, or intra template matching prediction (TMP).

4. The method of claim 3, wherein the partition split mode of the entry is selected from:
a first set of partition split modes, and the two prediction modes of the entry are both associated with inter-prediction;
a second set of partition split modes, and one of the two prediction modes of the entry is associated with IBC prediction or intra-prediction;
a third set of partition split modes, and one of the two prediction modes of the entry is associated with IBC prediction, intra TMP or intra-prediction; or
a fourth set of partition split modes, and one of the two prediction modes of the entry is associated with inter-prediction, IBC prediction, intra TMP or intra-prediction.

5. The method of claim 3, further comprising:
obtaining, based on the entry of the reordered candidate list indicated by the index, corresponding predictions of the two partitions through one or two members of a group including at least one of inter-prediction, intra-prediction, intra block copy (IBC) prediction, or intra template matching prediction (TMP).

6. The method of claim 5, further comprising:
obtaining a prediction of the video block by blending the corresponding predictions of the two partitions using weighted average.

7. The method of claim 6, further comprising:
obtaining a flag in the bitstream, wherein the flag indicates that a blending area size is one quarter, one half, double, or quadruple an existing area size.

8. An apparatus, comprising:
one or more processors; and
one or more storage devices storing computer-executable instructions that, when executed, cause the one or more processors to:
determine a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry is associated with inter-prediction;
obtain template matching costs for different entries of the plurality of entries having different partition split modes and different prediction modes;
obtain a reordered candidate list based on the template matching costs; and
determine one entry of the reordered candidate list indicated by an index in a bitstream.

9. The apparatus of claim 8, wherein the computer-executable instructions, when executed, cause the one or more processors to:
obtain a first template matching cost for a first entry of the plurality of entries having a first partition split mode and a first and second prediction modes; and
obtain a second template matching cost for a second entry of the plurality of entries having a second partition split mode and third and fourth prediction modes,
wherein the reordered candidate list is obtained by reordering the first and second entries based on a comparison of the first template matching cost and the second template matching cost.

10. The apparatus of claim 8, wherein the two prediction modes of the entry are associated with inter-prediction and a member of a group including at least one of inter-prediction, intra-prediction, intra block copy (IBC) prediction, or intra template matching prediction (TMP).

11. The apparatus of claim 10, wherein the partition split mode of the entry is selected from:
a first set of partition split modes, and the two prediction modes of the entry are both associated with inter-prediction;
a second set of partition split modes, and one of the two prediction modes of the entry is associated with IBC prediction or intra-prediction;
a third set of partition split modes, and one of the two prediction modes of the entry is associated with IBC prediction, intra TMP or intra-prediction; or
a fourth set of partition split modes, and one of the two prediction modes of the entry is associated with inter-prediction, IBC prediction, intra TMP or intra-prediction.

12. The apparatus of claim 10, wherein the computer-executable instructions, when executed, cause the one or more processors to:
obtain, based on the entry of the reordered candidate list indicated by the index, corresponding predictions of the two partitions through one or two members of a group including at least one of inter-prediction, intra-prediction, intra block copy (IBC) prediction, or intra template matching prediction (TMP).

13. The apparatus of claim 12, wherein the computer-executable instructions, when executed, cause the one or more processors to:
obtain a prediction of the video block by blending the corresponding predictions of the two partitions using weighted average.

14. The apparatus of claim 13, wherein the computer-executable instructions, when executed, cause the one or more processors to:
obtain a flag in the bitstream, wherein the flag indicates that a blending area size is one quarter, one half, double, or quadruple an existing area size.

15. A non-transitory computer readable storage medium storing a bitstream to be decoded by the decoding method according to claim 1.

16. A non-transitory computer readable storage medium storing a bitstream formed by instructions that, when executed by a computing device having one or more processors, cause the one or more processors to:
determine a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry is associated with inter-prediction;
obtain template matching costs for different entries of the plurality of entries having different partition split modes and different prediction modes;
obtain a reordered candidate list based on the template matching costs; and
transmit an index indicating one entry of the reordered candidate list in a bitstream, wherein the bitstream is to be decoded by the decoding method according to claim 1.

17. A method for storing a bitstream, comprising:
determining a candidate list comprising a plurality of entries for a video block, wherein an entry of the plurality of entries contains one partition split mode indicative of a partition of the video block into two partitions and two prediction modes for the two partitions respectively, and at least one of the two prediction modes of an entry is associated with inter-prediction;
obtaining template matching costs for different entries of the plurality of entries having different partition split modes and different prediction modes;
obtaining a reordered candidate list based on the template matching costs;
transmitting an index indicating one entry of the reordered candidate list in a bitstream; and
storing the bitstream, wherein the bitstream is to be decoded by the decoding method according to claim 1.
